(19) United States
(12) Patent Application Publication
(10) Pub. No.: US 2011/0047189 A1
(43) Pub. Date: Feb. 24, 2011

(54) Integrated Genomic System

(75) Inventors: Hans-Martin Will, Redmond, WA (US); Mark B. Anderson, Redmond, WA (US)

Correspondence Address: LEE & HAYES, PLLC, 601 W. RIVERSIDE AVENUE, SUITE 1400, SPOKANE, WA, 99201, US

(73) Assignee: Microsoft Corporation, Redmond, WA (US)

(21) Appl. No.: 12/678,196

(22) PCT Filed: Sep. 30, 2008
(86) PCT No.: PCT/US08/78311

§ 371 Date: Nov. 9, 2010

Related U.S. Application Data
(60) Provisional application No. 60/976,745, filed on Oct. 1, 2007.

(51) Int. Cl. G06F 15/16; G06F 17/30

(52) U.S. Cl. 707/803; 709/203; 707/E17.044

(57) ABSTRACT

An integrated genomic system is a software system that facilitates data management and analysis connected with integrated genomic research, such as statistical genetics. Reference information, biological and experimental, describes context from which experiments are made. Reference information, including annotations for genes, markers, study, individuals, and so on, is input into the integrated genomic system for consolidation, accessibility, and linkage with other data to aid researchers to view influences and interactions in biological systems.

### FIELD OF THE INVENTION

The present invention is generally related to a software framework, and more specifically, to a computer-implemented architecture of an integrated genomic system for data management and analysis in connection with genomic research.

### BACKGROUND

Large scale, high throughput technologies used by the biological sciences have caused a shift away from reductionism in favor of systems biology. New tools are now available to look at tens of thousands of genes in different tissues in different states. Genomic sequencing has been completed for a plethora of organisms and a growing computational infrastructure has enabled views of DNA, RNA, and protein data to elucidate the fundamental nature of diseases and living systems generally. The future success of such research will likely demand a more comprehensive view of the complexity of interactions in biological systems and how such interactions are influenced by genetic background, infection, environmental states, life-style choices, and social structures.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter. A system, method, and computer-readable medium for analyzing interactions in biological systems are provided.

In accordance with this invention, a system form of the invention includes a group of network computers for viewing influences on interactions in biological systems selected from a group consisting of genetic background, infection stages, environmental states, life-style choices, and social structures. The group of network computers comprises a client application being executed on a client machine through which a user accesses a visual interface for viewing influences on interactions in biological systems. The group of network computers further comprises an application server being executed on a server machine for hosting applications and a job execution framework for off-loading jobs from the client application and automatically executing the jobs comprising the importation of biological data, statistical analysis, and a transformation of biological data. The group of network computers further comprises a relational database server storing reference information for genetic studies, participating study populations, and genetic markers that are under investigation. The group of network computers further comprises a Web-enabled collaborative document repository server, which is used to store and access two-dimensionally indexed structures containing data matrices of genotype calls organized by study, individual, and genetic marker. Both the relational database and the Web-enabled collaborative document repository server can be physically hosted on the same server machine as the application server in one embodiment. In other embodiments, the relational database and the Web-enabled collaborative document repository server are physically not hosted on the same server machine as the application server.

In accordance with further aspects of this invention, a method form of the invention includes a method for analyzing interactions in biological systems. The method comprises creating a study to capture a population of individuals being genotyped to calculate statistical results about a specific assay used to measure genetic variations for a set of markers. The method further comprises the loading and copying of external genotype data files into data load data sets. The method further comprises creating a study data set to associate a genotype call with each individual and marker that are associated with the study by reconciling genotype calls for samples across one or more data load data sets. The method further comprises creating an analysis data set to focus on a subset of the study data set by restricting the data shown to data points associated with a given individual list and marker list. The analysis data set is a two-dimensional organization of genotype information and markers without using a copy of genotyping data.

### DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is a block diagram illustrating an exemplary integrated genomic computer network (integrated genomic system);

FIG. 2 is a block diagram illustrating an exemplary client-server network of an integrated genomic system;

FIG. 3 is a block diagram illustrating an exemplary compute cluster of an integrated genomic system;

FIGS. 4A-4E illustrate an exemplary flow diagram of an integrated genomic system;

FIGS. 5A-5R are structure diagrams illustrating exemplary data structures, such as database tables, of an integrated genomic system; and

FIGS. 6A-6P are process diagrams illustrating exemplary methods for creating studies, loading genotype data, and analyzing interactions of biological systems.

### DETAILED DESCRIPTION

With new technologies and available genomic analysis tools, research organizations throughout the biotechnology industry are struggling with the most mundane data management activities in order to begin to understand the massive amounts of data generated by the laboratories. New assay technology comes with its own proprietary file formats different from those of existing assay technologies, adding to the confusion. Only a few public standards for exchange of bioinformatics data have been developed, and those public standards are not well used. One key reason for this is the realization that complex domains lead to a complex data model underlying those public standards which in turn forms a significant entry barrier for adoption in typical laboratory environments.

Aside from using assay results from a multitude of technology platforms, pieces of data are typically dispersed, and they are not associated with reference information describing the experimental and biological context. Examples of reference information include annotation for genes, markers, samples, individuals, and phenotypes that are associated with individuals and samples. Accessing and consolidating all of these pieces of data across a multitude of files and across databases is challenging. If these operations were to be performed manually or even in a semi-automated fashion, the process would introduce significant room for potential errors in the data analysis and subsequent interpretation.

In addition, the genome of most organisms is still not fully finalized, which means that biological entities, such as sequences, transcripts, markers, and genes get revised, merged, or retired more often than is known. These changes to the biological context in which data analysis tasks are performed pose challenges for revisiting biological interpretation analysis results at a later point in time.

Data analysts, such as statistical geneticists, who want to develop new analysis methodologies select the analysis method of choice from a vast set of analysis tools that has been developed by the research community. In the field of computational genetics, more than 1500 tools have been cataloged. A number of these analysis tools use proprietary file formats. In a typical setup, each of these tools will generate one or more result files in their proprietary format. If the analysis method has high computational demands that require execution in a clustered environment, another degree of complexity is added. For the majority of analysis tools, their input file formats are not optimized for quick access to selected subsets, as needed for parallelization of computational resources.

Scientists quickly accumulate a large number of analysis results, which requires a method for organizing and structuring these files in a way that allows for quick retrieval, comparison, and cross-referencing such results within and across studies, and with colleagues that may work across the globe. In order to make sense of analysis results archived in such a form, these results should be related back to the original data sets used as input to the analysis tools and alongside the parameters and version of the analysis tools. In addition, such an archive may need to perform revision and access control in order to ensure traceability of changes over time. Finally, data retrieval can become more effective if merged statistical results become annotated at a high level that ties numerical results back to their scientific background and interpretation.

Various embodiments of the present invention focus on an integrated genomic system to provide data management capabilities for data set generation and analysis work flow support in the domain of statistical genetics as well as other domains of genomic studies. Various embodiments of the present invention provide an organization-wide repository of biological reference information associated with genetic studies. In particular, such information entails storage about genes and genetic markers that are the subjects to be discovered in scientific investigation.

Various embodiments of the present invention provide an organization-wide data repository that captures genetic studies across research projects. Such information may entail information about the study design underlying the scientific experiment. One example includes a case-control associations study versus family-based analysis. Other pieces of information connected with a scientific experiment include experimental setup, cohorts of individuals participating in the study, assay technology used to determine genetic variation, and technology-specific information about the set of genetic markers that was targeted in the experiment.

Various embodiments of the present invention provide a repository for assay results, where each data point in the result set links back to biological reference information and study design information. Various embodiments of the present invention implement quality control measures and procedures to exclude unreliable or questionable data points from downstream analysis. Various embodiments of the present invention provide efficient methods for transforming a set of genetic variation measurements using a variety of external analysis tools and enrich the data set as needed by incorporating reference information from the biological study design annotation, as required by the specific analysis method.

Various embodiments of the present invention provide a common analysis result repository that controls access and revisions for a variety of analysis results types that can be generated by a plethora of analysis tools available to statistical geneticists and expose those analysis results to a variety of built-in visualization tools. Various embodiments of the present invention capture, for each analysis result or intermediate step of data processing, parameters and input values for the re-creation of audit trails from each data point in an analysis result back to the system boundaries. Various embodiments of the present invention provide means for the sharing of data sets analysis results for users working within an instance of the integrated genomic systems, as well as for users working across multiple instances of the integrated genomic systems.

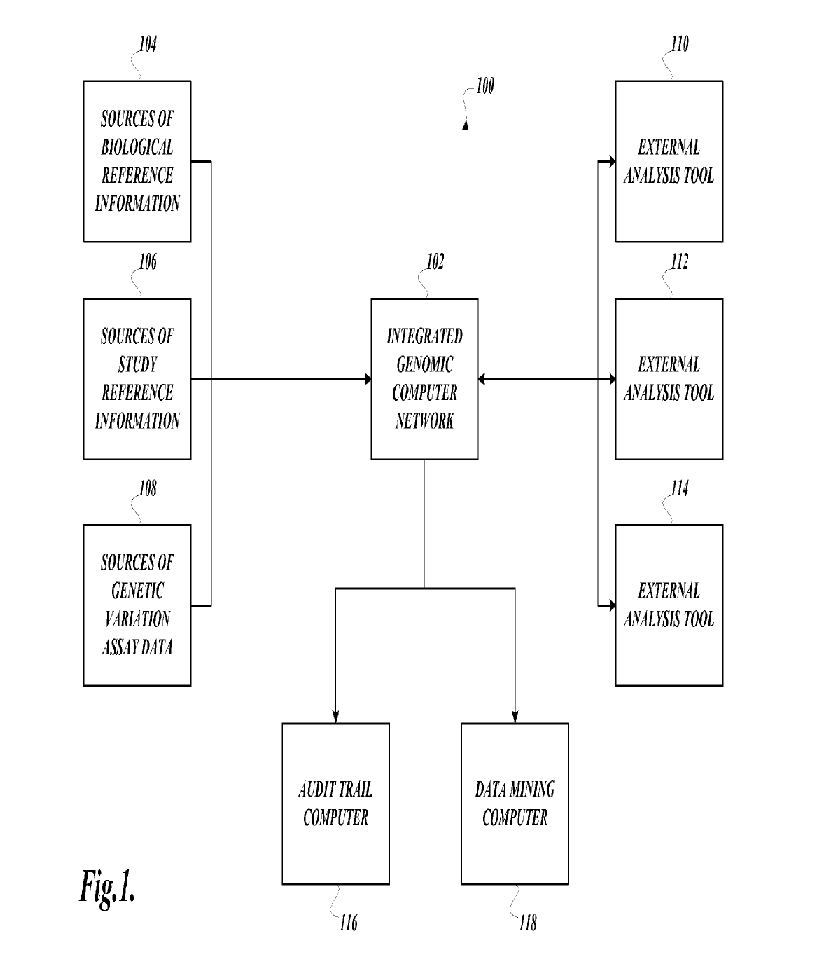

FIG. 1 illustrates a system 100 that includes an integrated genomic computer network 102 (integrated genomic system), which is a software system that facilitates data management and analysis connected with integrated genomic research, such as statistical genetics. Sources of biological reference information 104 describe the biological context from which experiments are made. Such biological reference information, including annotations for genes, markers, and so on, is input into the integrated genomic system 102 for consolidation, accessibility, and linkage with other data to aid researchers to view influences and interactions in biological systems.

Similarly, sources of study reference information 106 provide study reference information to the integrated genomic system 102. Examples of study reference information include those that are connected to the experimental context, such as samples, individuals, phenotypes, and end-point data associated with individuals and samples. These pieces of study reference information are also accessible, consolidated, and linked so as to also further aid researchers in the analysis and viewing of influences or interactions of biological systems.

Information connected with sources of genetic variation assay data 108 is provided to the integrated genomic system 102. The assay data may come from a multitude of technology platforms and the integrated genomic system 102 consolidates and links assay data to both biological reference information and study reference information to fully describe the experimental and biological context to a researcher.

External analysis tools 110-114 are a few among many analysis tools available to a researcher. Various embodiments of the present invention allow the integrated genomic system 102 to send data sets to these external analysis tools 110-114, invoking the external analysis tools 110 to perform work on the data sets, and the analysis results from these external analysis tools 110-114 are then imported back into the integrated genomic system 102 to help researchers better understand and analyze genomic studies.

The integrated genomic system 102 includes an access control capability to note users who have read access and those users who have read-write access to each object in the integrated genomic system 102. Revision information is maintained for each object, providing comprehensive setup auditing records identifying when a modification was done to an object and by whom, thereby facilitating the creation of audit trails by audit trail computer 116 within the integrated genomic computer network 102. A data mining computer 118 is available and on which analysis tools internal to the integrated genomic computer network 102 can be executed to view consolidated data that has been filtered to exclude or include using quality control scores.

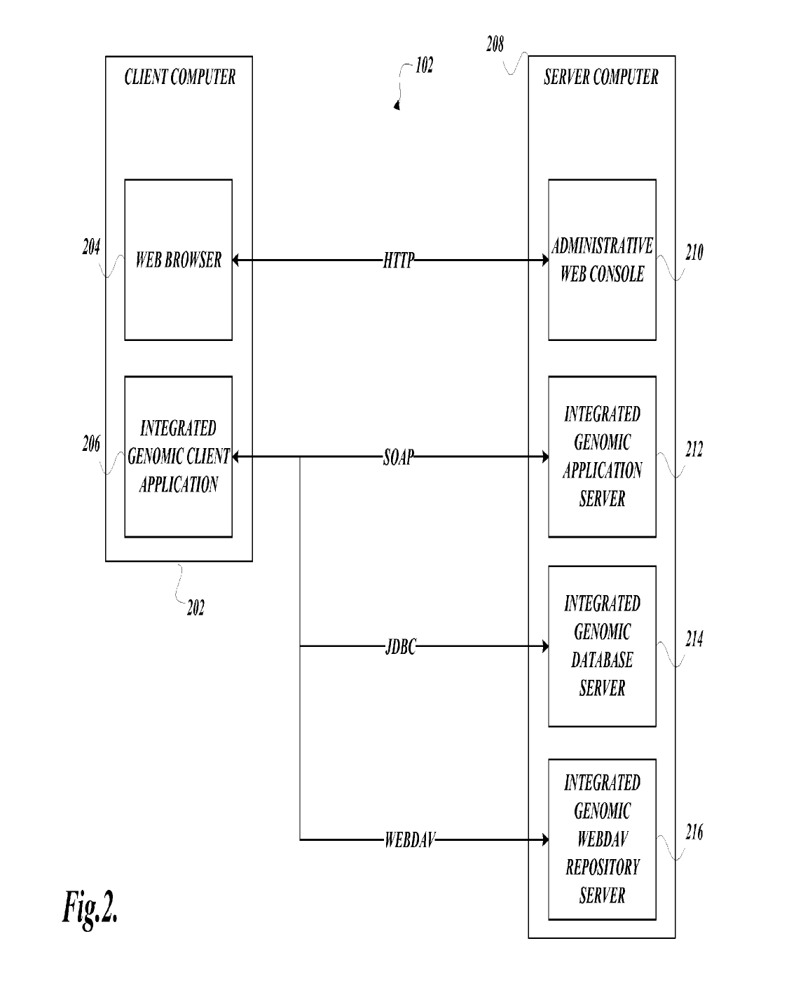

FIG. 2 illustrates the integrated genomic system 102 in greater detail. One suitable architecture includes a three-tiered system, which is deployed on two types of machines, including one or more client computers 202 and one or more server computers 208. For brevity purposes, only one client computer 202 and only one server computer 208 are illustrated. The client computer 202 hosts various integrated genomic client applications 206 connected with the integrated genomic system 102 and which are operated by an end-user (researcher) of the integrated genomic system 102. A Web browser 204 is available on the client computer 202 usable by the end-user to connect to an administrative Web console 210 deploying remotely on the server computer 208. The client computer 202 includes integrated genomic client application 206, featuring a rich visual interface which connects to one or more server computers 208. The client computer 202 employs a variety of standardized protocols to communicate with the server computer 208, such as HTTP for communication with administrative Web console 210, SOAP for communication with an integrated genomic application server 212, JDBC for communication with an integrated genomic database server 214, and WEBDAV for communication with an integrated genomic WEBDAV repository server 216.

The administrative Web console 210 running remotely on the server computer 208 is a Web-based application performing administrative tasks on the server computer 208. Various administrative tasks include setting up and configuring end-user accounts, creating and restoring backups, deploying upgrades to software, and reviewing the status of automatic job processing currently being performed by the integrated genomic application server 212. The integrated genomic database server 214 includes a relational database that is part of the integrated genomic system. The integrated genomic database server 214 serves as repository for structural information and reference data that needs to be maintained across research projects within one or more organizations. The integrated genomic WEBDAV repository server 216 includes an implementation of a server-side piece of the World Wide Web distributed authoring and versioning protocol. The integrated genomic WEBDAV repository server 216 exposes a hierarchically-organized storage of files, which are maintained with access and revision control.

The integrated genomic application server 212 hosts a framework for automatic job execution in which jobs may be submitted by researchers from the client computer 202 via the integrated genomic client application 206. Because many of the tasks that can be performed using the integrated genomic system 102 can have high demands on computational and memory resources, those tasks can be off-loaded from the client computer 202 to the server computer 208 via the use of an automatic job execution framework made available by the integrated genomic computer network 102. Examples of such tasks include the importing of large quantities of data, performing complex statistical analysis, or performing complex data transformation and data merging activities.

Another suitable alternative architecture for the integrated genomic system 102 includes the use of a compute cluster, which is a group of independent network servers that operate-and appear to clients-as if they were a single unit. A cluster network is designed to improve network capacity by, among other things, enabling the servers within a cluster to shift work in order to balance the load. By enabling one server to take over for another, a cluster network also enhances stability and minimizes or eliminates downtime caused by application or system failure. The compute cluster is typically physically collocated. A non-collocated alternative architecture according to another embodiment is a compute grid, which provides similar functionality as the compute cluster, but it is distributed through multiple nodes. Compute grids connect collections of computers that are geographically dispersed. Compute grids typically support heterogeneous computation environment. Grid computing is optimized for workloads which consist of many independent jobs, which do not have to share data between the jobs during the computation process. Grids serve to manage the allocation of jobs to computers which will perform independent work. Resources such as storage may be shared by all the nodes, but intermediate results of one job do not affect other jobs in progress on other nodes of the compute grid. In these two embodiments, an automatic job execution framework on a server may distribute computationally-intensive data analysis jobs to a compute cluster or a compute grid.

Another suitable alternative architecture for the integrated genomic system 102 includes an embodiment where the integrated genomic client application 206 is a thin client such that a large subset of the functionality provided by the integrated genomic client application 206 is provided instead through the Web browser 204 using Web services executing on the server computer 208. Another suitable alternative architecture for the integrated genomic system 102 includes an embodiment where a view into the integrated genomic WEBDAV repository server 216 is mounted as a virtual file system on the client computer 202. With repository content of the integrated genomic WEBDAV repository server 216 being exposed as virtual file systems, third party applications executing on the client computer 202 can directly access data sets stored and maintained by the integrated genomic system 102 through file system operations.

Another suitable extended architecture, according to another embodiment of the present invention, includes the use of multiple server machines to form an integrated genomic system. Using load balancing principles, the administrative Web console 210, the integrated genomic application server 212, and the integrated genomic WEBDAV repository server 216 are deployed on one server computer 208. An application server framework (not shown), however, can be deployed on more than one server computers 208. On a second computer server 208, the integrated genomic application server 212, the integrated genomic database server 214, and the integrated genomic WEBDAV repository server 216 are deployed on the second server computer 208. On a third server computer 208, the integrated genomic application server 212 can be deployed. A set of jobs submitted to the job execution framework can be processed using the combined computational and memory resources available on one or more server computers 208 that host an instance of the integrated genomic application server 212.

The integrated genomic WEBDAV repository server 216 need not be run on the server computer 208; instead, a suitable external WEBDAV-enabled repository can be used. One suitable external WEBDAV-enabled repository includes Microsoft Sharepoint. If deployed in this fashion, the hierarchy of files maintained by the integrated genomic system 102 may show up as one or more subtrees in the external repository. Experimental data organized and maintained by the integrated genomic system 102 can be made directly available to a common enterprise information worker infrastructure facilitated by the external WEBDAV-enabled repository.

In one embodiment of the present invention, the server computer 208 has network access to a remote file system that is shared with a system hosting automation software of a genotyping platform used in the laboratory. As part of conducting the experimental work, the automation software may deposit new data sets into the common remote file system accessible by the server computer 208. The automatic job execution framework may scan the remote file system at regular intervals and create data import tasks in the job list for each new data set that is being discovered in the scanning process. When the import task is to be dispatched for execution by the framework, the data set will be imported into the integrated genomic system 102, and upon successful completion, the data set in the remote file system may be discarded. In this embodiment, a fully automated data pipeline from laboratory equipment, such as a genotyping platform, may be facilitated into the integrated genomic system 102.

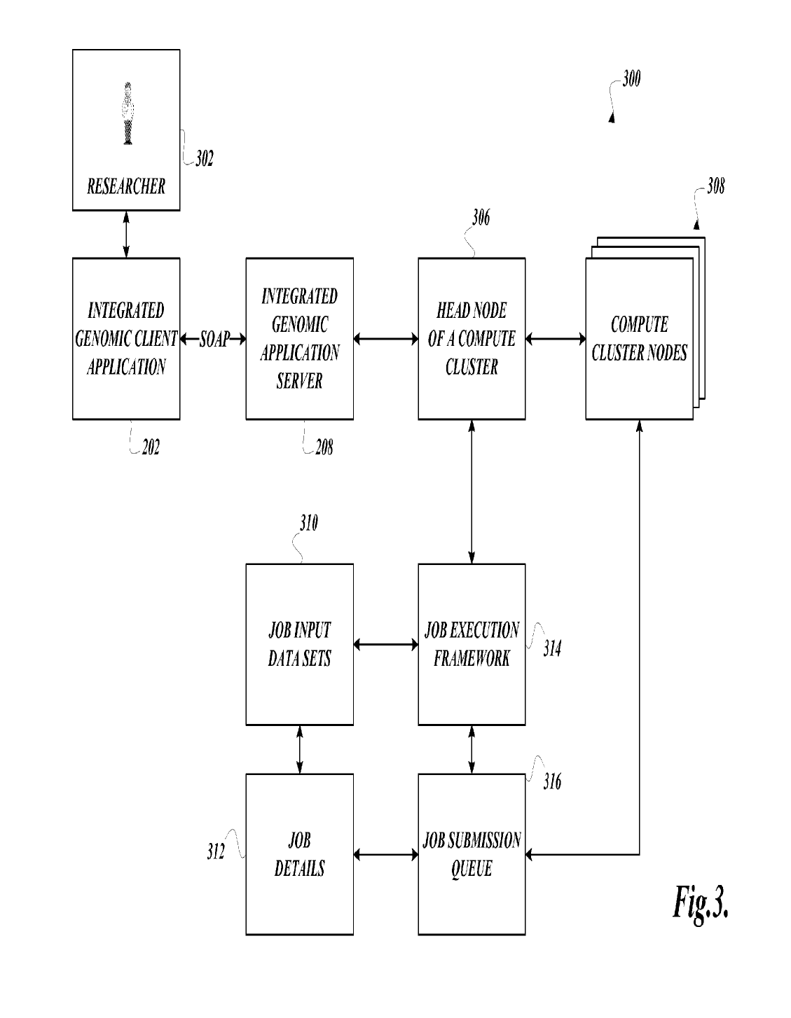

FIG. 3 illustrates compute cluster integration 300. A computer cluster integration 300 is physically collocated. However, any suitable computation infrastructures may be used. One suitable computation infrastructure that would implement similar functionality as the compute cluster integration 300 is a compute grid, which is physically distributed. A researcher 302 may use software functionality of the integrated genomic client application 202 to request job processing via the integrated genomic application server 208. The integrated genomic application server 208 has network access to a head node of a compute cluster 306. There are a number of compute cluster nodes 308 which are linked to one another and are identifiable by the head node 306. A job execution framework 314 also has network access to a job submission queue 316 of the compute cluster integration 300. As part of submitting tasks for automatic execution, as mentioned previously, the researcher 302 uses the integrated genomic client application 202 to request job processing to occur using the compute cluster integration 300. When a job, being definable by the job input data sets 310 and job details 312, destined for the compute cluster integration 300 is picked up by the job execution framework 314, the job input data sets 310 are transferred to the head node 306, and the job details 312 are transferred into the job submission queue 316 of the compute cluster integration 300. The job is then dispatched and executed. The job execution framework 314 monitors the execution status of the job (310, 312) and upon completion, the job execution framework 314 collects the analysis results from the head node 306 and imports them back into the integrated genomic system 102 via the integrated genomic application server 208.

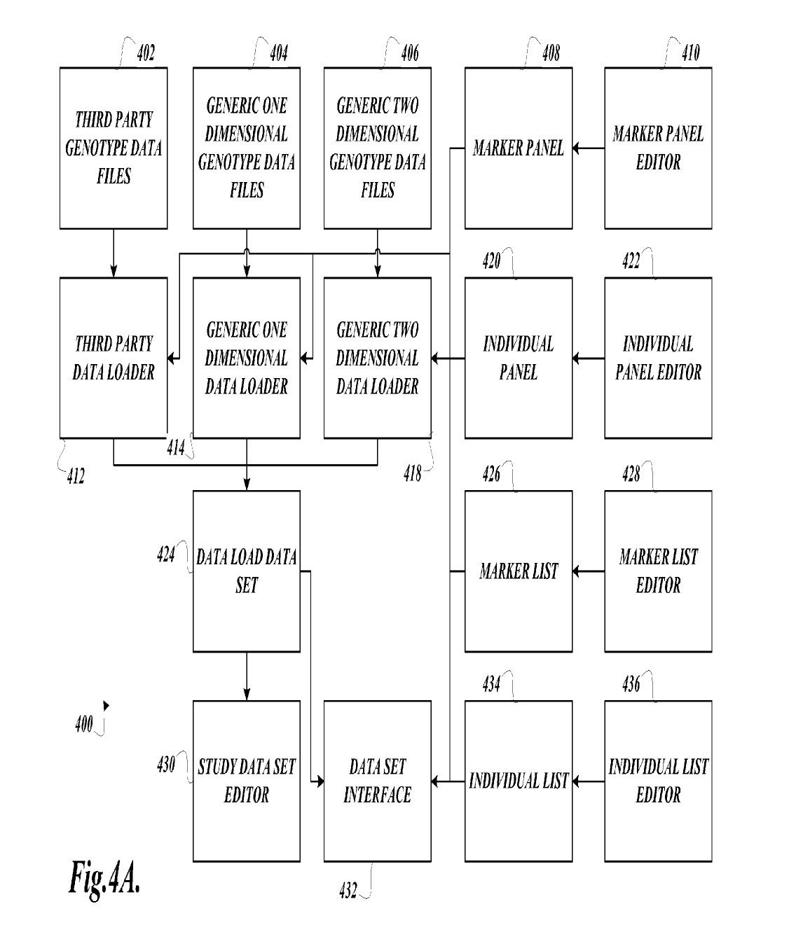

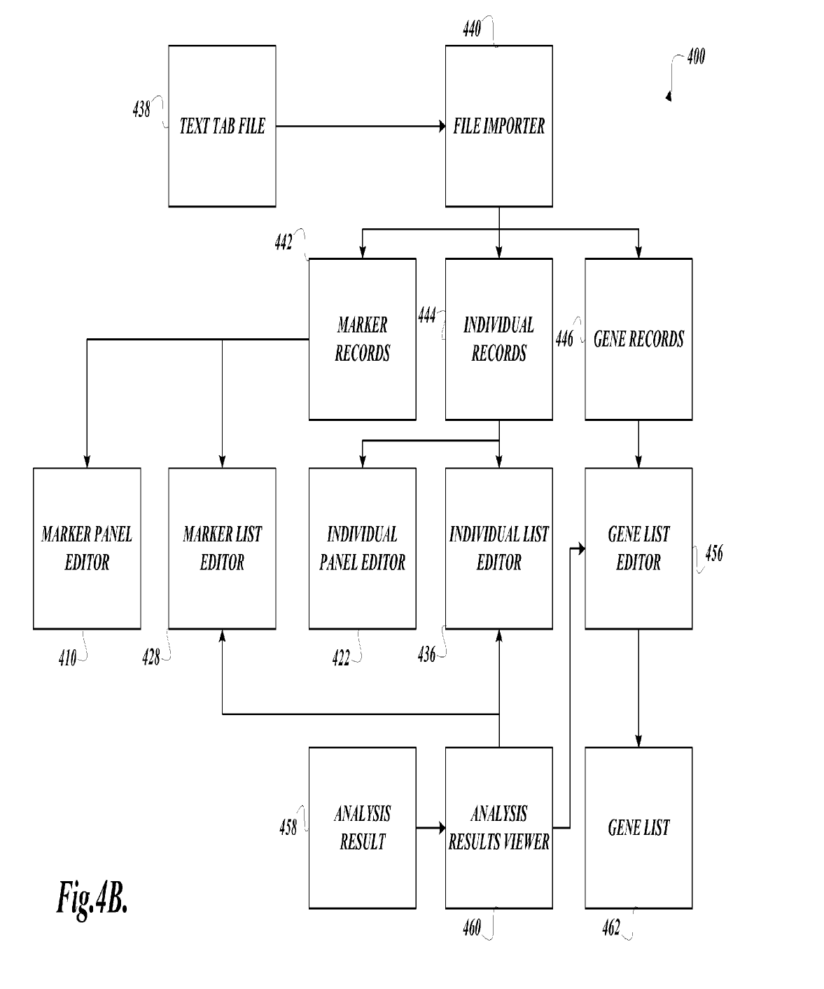

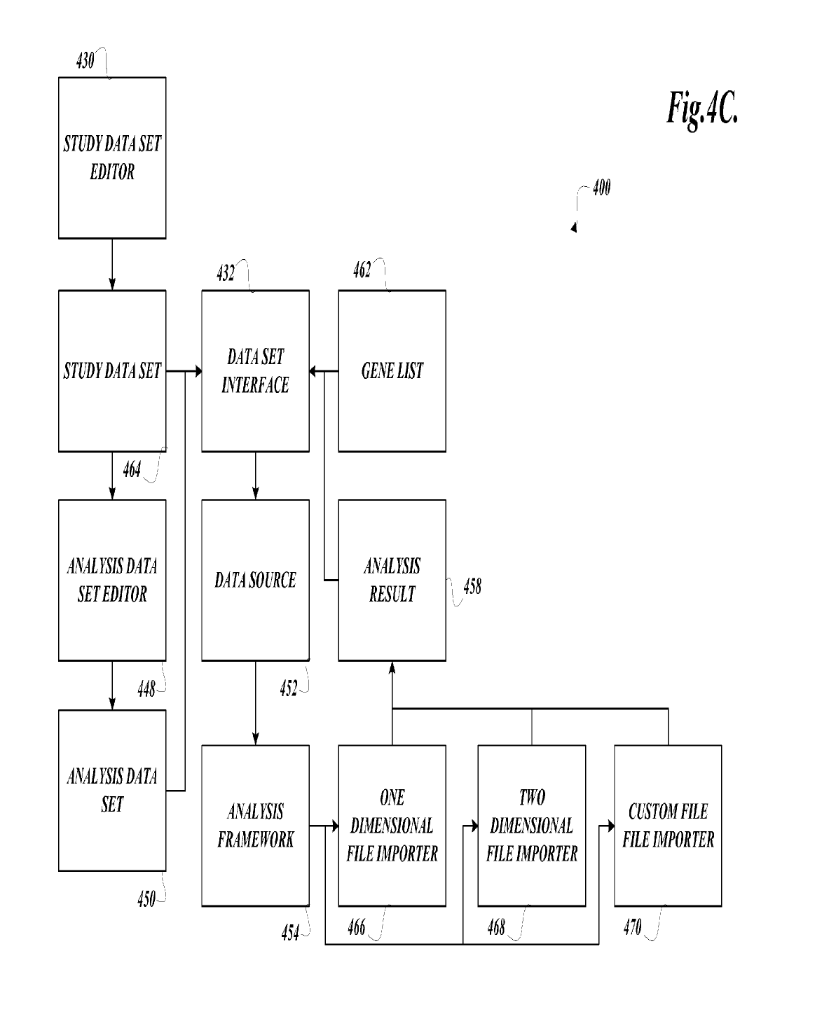

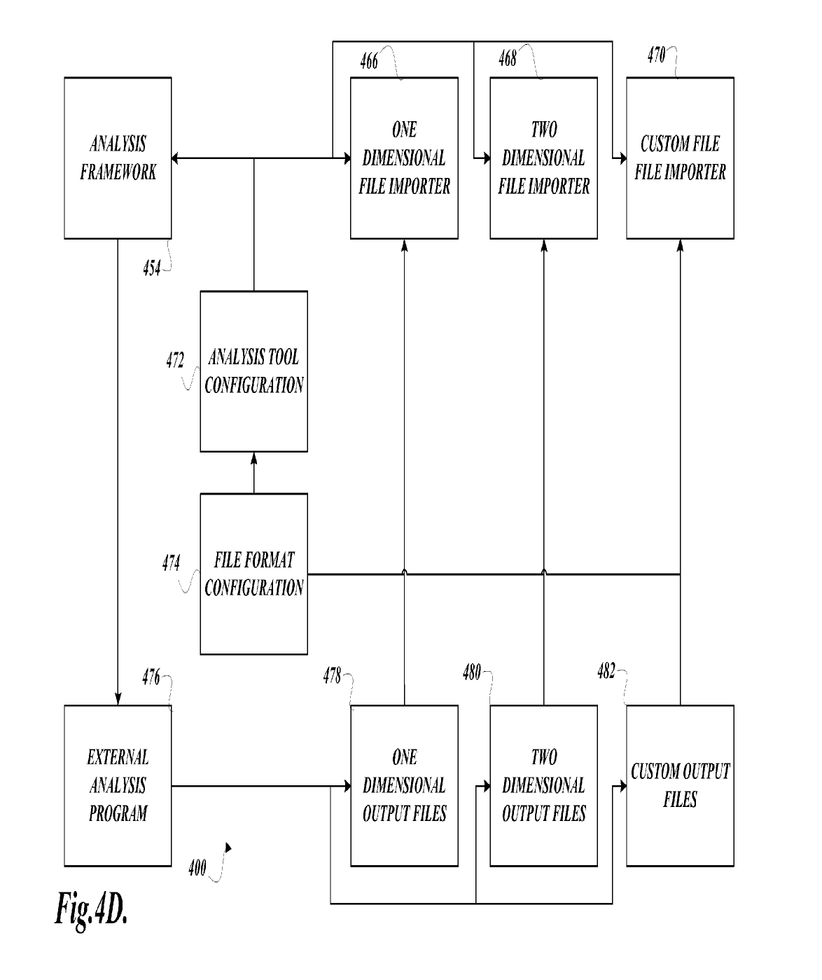

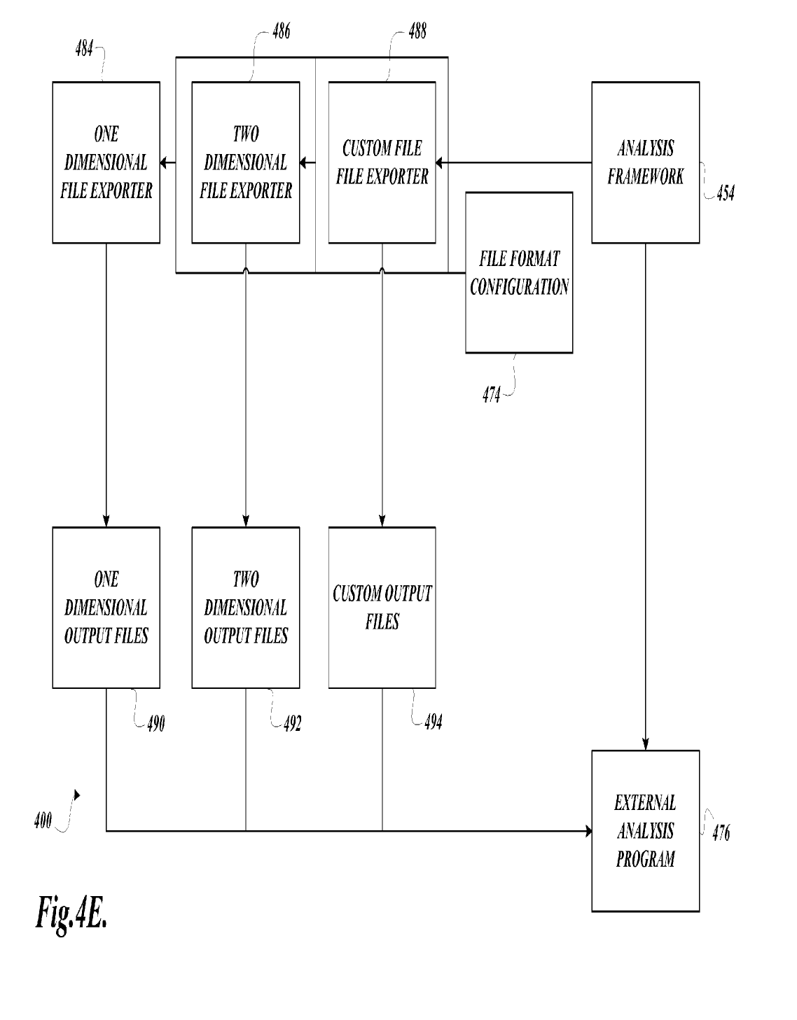

FIGS. 4A-4E are block diagrams that illustrate data flow 400 within the integrated genomic system 102 and its invocation of external analysis tools. The data flow 400 describes movement of data of the integrated genomic system 102 from entry to destination. As previously discussed, the integrated genomic system receives genotype data so as to allow consolidation and linkage to aid researchers in their analysis and viewing of influences and interactions in biological systems.

In the data flow 400, third party genotype data files 402, generic one-dimensional genotype data files 404, and generic two-dimensional genotype data files 406 are data files. Data files contain data in the form of text or numbers as distinct from an object comprising both data and instructions. These data files 402-406 are loaded into the integrated genomic system 102 via usage of one or more third-party data loaders 412, which are processing components. A processing component contains computer instructions that are executable to perform one or more tasks, such as loading data into an object of the integrated genomic system 102.

Data loaders 412-418 include third party data loaders, generic one-dimensional data loaders, and generic two-dimensional data loaders. These data loaders are processing components that include computer-executable instructions for loading data in the data files 402-406 to a data object, such as a data load data set 424 in the integrated genomic system 102. The data load data set 424 is an instantiation of a data structure, which comprises a sample manifest (to be explained below), a reference to a marker panel (to be explained below also), and for each combination of sample and marker from the sample manifest and marker panel, an associate set of alleles that has been experimentally determined for the sample and marker in a genotyping assay experiment. This set of alleles is also defined as a genotype call.

Data objects, such as marker panel 408, individual panel 420, marker list 426, and individual list 434, are used by the data loaders 412-418 to determine information from data files 402-406 to cull and provide to the data load data set 424, which is a data object. The data object marker panel 408 is an instantiation of a data structure that defines a set of markers alongside the specific assay that can be used to determine their variations in a sample of DNA. For SNPs, the marker panel will include the specific flanking sequences used to locate the marker within a sample of DNA, alongside information from which, of the two strands forming a chromosome, the data point will be obtained by the assay. During loading of genotype data from data files 402-406 by data loaders 412-418, this information can be used to validate incoming data and to automatically recode data against a strand that is indicative as primary strand for an SNP in a reference database, such as NCBI dbSNP.

The data object individual panel 420 is an instantiation of a data structure which represents a population of individuals participating in a study. A study panel can group the overall set of individuals into subpanels and subpopulations based on the specific design of the study. For example, in a case versus control study, the individual panel might identify individuals as belonging to a group of cases versus a control group. In a family-based linkage study, the individual panel might group the participating individuals by their families. The data object marker list 426 is an unordered collection of genetic markers. The data object individual list 434 is an unordered collection of individuals.

Processing components, such as marker panel editor 410, individual panel editor 422, marker list editor 428, and individual list editor 436, aid a researcher in deciding which markers and individuals information obtained from another data file to include as members of the data objects marker panels 408, individual panels 420, marker list 426, and individual list 434. The marker panel editor 410 decides whether a marker record is to be created, read, updated, or deleted in the marker panel 408. The individual panel editor 422 decides whether an individual record is to be created, read, updated, or deleted in the individual panel 420. The marker list editor 428 decides whether a marker record should be created, read, updated, or deleted from the marker list 426. The individual list editor 436 decides whether an individual record should be created, read, updated, or deleted from the individual list 434.

The data objects, such as data load data set 424, individual panel 420, marker list 426, and individual list 434, expose corresponding records of information to the data set interface 432, which then aggregates and consolidates the records of data for later use by the integrated genomic system 102. The data object data load data set 424 is used by a processing component study data set editor 430 to produce a study data set, which is a data object and is discussed below. The data flow 400 includes data coming from a text tab-delimited file 438, which is a data file. The text tab-delimited file 438 includes information regarding markers, individuals, and genes. The data in the text tab-delimited file 438 is imported by a processing component file importer 440 into temporary internal objects marker records 442, individual records 444, and gene records 446. These records 442-446, once created, read, or updated by editors 410-456, are removed from the integrated genomic system 102. The gene list editor 456 adds gene records to a gene list 462, which is a data object.

A processing component analysis results viewer 460 communicates with the marker list editor 428, individual list editor 436, and gene list editor 456 by requesting these editors to cull information from the marker list 426, individual list 434, and the gene list 462, along with analysis result 458 to be presented to the researcher who is using the integrated genomic system 102. The analysis result 458 includes numerical information associated with an individual, a sample, a marker, a gene, or a pair or triple of objects from various lists 426, 434, and 462.

The data object study data set 464 exposes its data to the data set interface 432. Digressing, the dimensionality of the study data set 464 is different from the dimensionality of the data load data set 424. The dimensionality of the data load data set 424 is based on the number of samples (multiple samples can be taken from an individual) and markers in a study. The dimensionality of the study data set 464 is based, instead, on an individual and markers. Because more than one sample can be associated with an individual, at the time the study data set 424 is instantiated, a set of quality control rules is executed to resolve ambiguity or conflict regarding the inclusion or exclusion of certain pieces of information connected with a single individual that are derived from different samples. Such quality control rules include: exclusion of data and mark a record in the audit log that there has been an ambiguity or conflict of information; use a data point with the highest confidence value (if the assay platform from which the samples were taken provides such a quality control score); or manual editing by a researcher using the study data set editor 430 prior to the production of the study data set 464.

Returning, gene information contained by the gene list 462 is also exposed to the data set interface 432. The study data set 464 is used by a processing component analysis data set editor 448, which aggregates and reconciles the data contained in the study data set 464 to produce a data object analysis data set 450. The analysis data set 450 is a view of a subset of a study data set 464 by restricting the data shown to data points associated with a given individual list 434 and the marker list 426. These individual lists and marker lists can be implicitly defined using quality control cut-off parameters on summary statistics associated with individuals and markers for the underlying study data set 464. The analysis data set 450 is then exposed to the data set interface 432. Also exposed to the data set interface 432 is the analysis result 458. The data set interface 432 aggregates these pieces of data and provides them to an interface data source 452.

The data source 452 is used by the analysis framework 454 to aid a researcher in viewing influences and interactions of biological systems. The analysis framework 454 may invoke processing components, such as one-dimensional file importer 466, two-dimensional file importer 468, and/or custom-file file importer 470 for importing external data from external analysis tools and create information associated with individuals, samples, markers, and genes for the analysis result 458 for later presentation to the researcher. The analysis framework 454 communicates with a data objects analysis tool configuration 472, which captures information to parameterize the invocation of an external piece of software representing a desired analysis tool. This includes operating system-specific information about the external piece of software to be executed, the structure of its command line invocation, and the format specification for command line argument values as well as necessary input and output files. The external piece of software can be either platform-specific binary program executable or can be encoded as byte-code or scripted program text that is invocable by the integrated genomic system 102.

The analysis tool configuration 472 uses a data object file format configuration 474 to determine various file formats that are proper for use to invoke the external piece of software representing the desired analysis tool. The file format configuration 474 defines a mapping from an external file format used by the external analysis tool from or to a data object that is part of the integrated genomic system 102. In particular, the data object includes an individual, a sample, a marker, a gene, a matrix of genotyping calls, and analysis results. The information contained by the file format configuration 474 is used by file importers 466-470 to import data into the integrated genomic system 102. The analysis framework 454 invokes one or more external analysis program(s) 476. After analysis results are obtained, the external analysis program 476 writes these analysis results to a number of output files, such as one-dimensional output files 478, two-dimensional output files 480, and custom output files 482. These output files are data files that are then parsed by file importers 466-470 to create analysis results viewable by the researcher using the integrated genomic system 102. The custom output files 482 can be designed to include multi-dimensional data for later parsing and extraction.

The analysis framework 454 invokes various processing components, such as one-dimensional file exporter 484, two-dimensional file exporter 486, and custom-file file exporter 488. The custom-file file exporter 488 may export data from within the integrated genomic system 102 to an external analysis program 476 using dimensions different from those prescribed by file exporters 484, 486. The file exporters 484-488 use the file format configuration 474 to understand how to format data from within the integrated genomic system 102 into a form that can be read by the external analysis program 476. After processing, the file exporters 484-488 produce one or more data files, such as one-dimensional output files 490, two-dimensional output files 492, and custom output files 494. The custom output files 494 can have dimensional presentation of data different from other output files 490, 492. The external analysis program 476 parses data from one or more output files 490-494 to help it in its analysis execution.

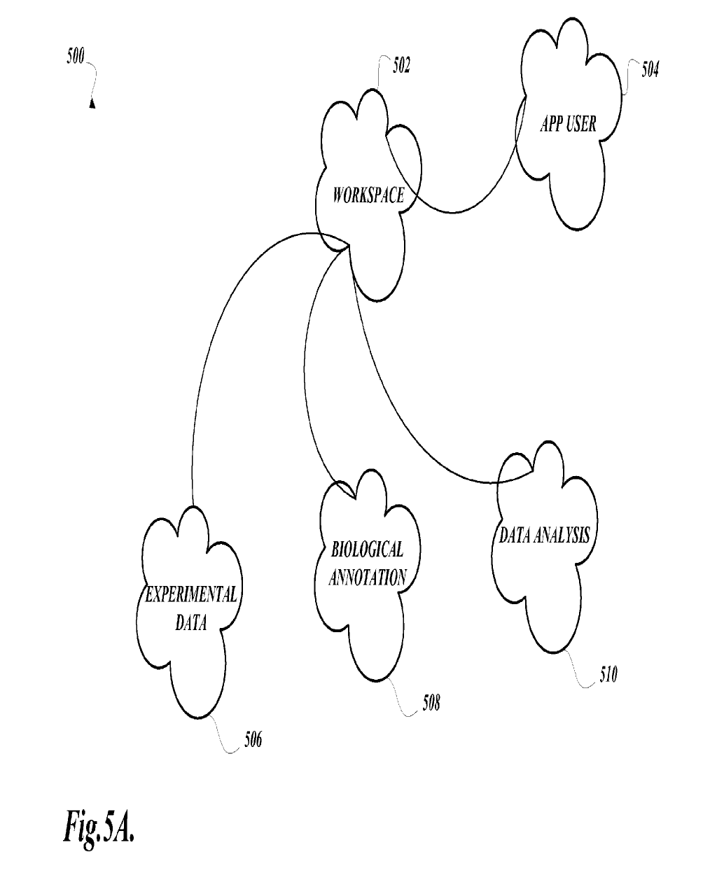

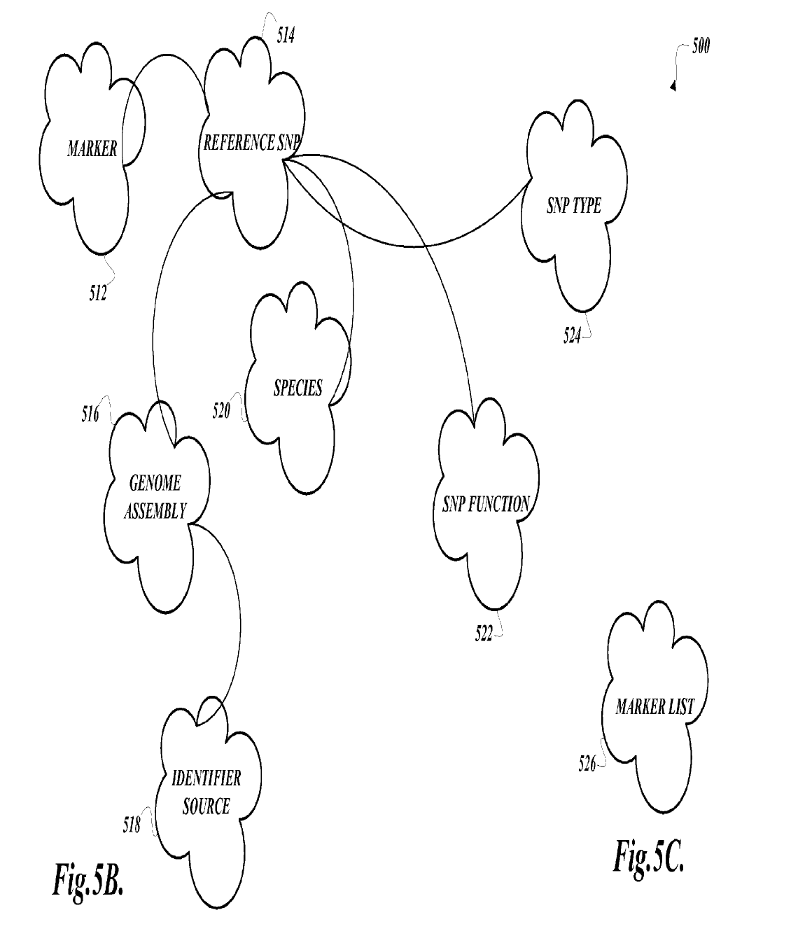

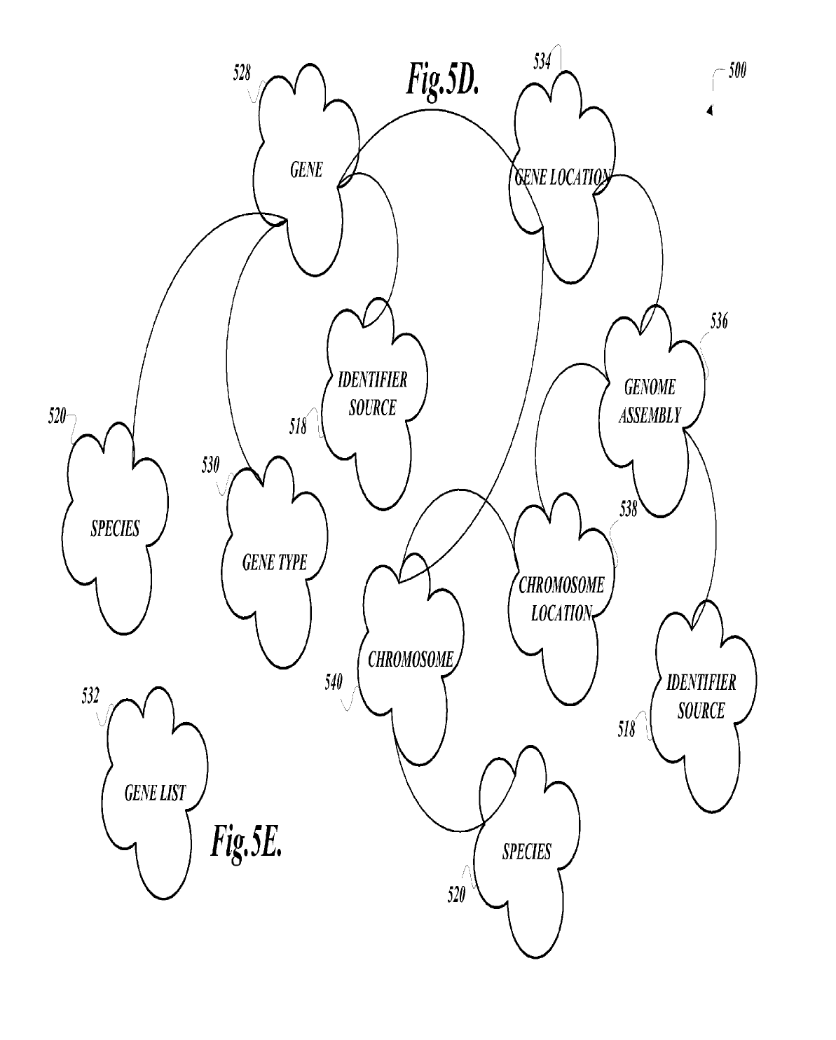

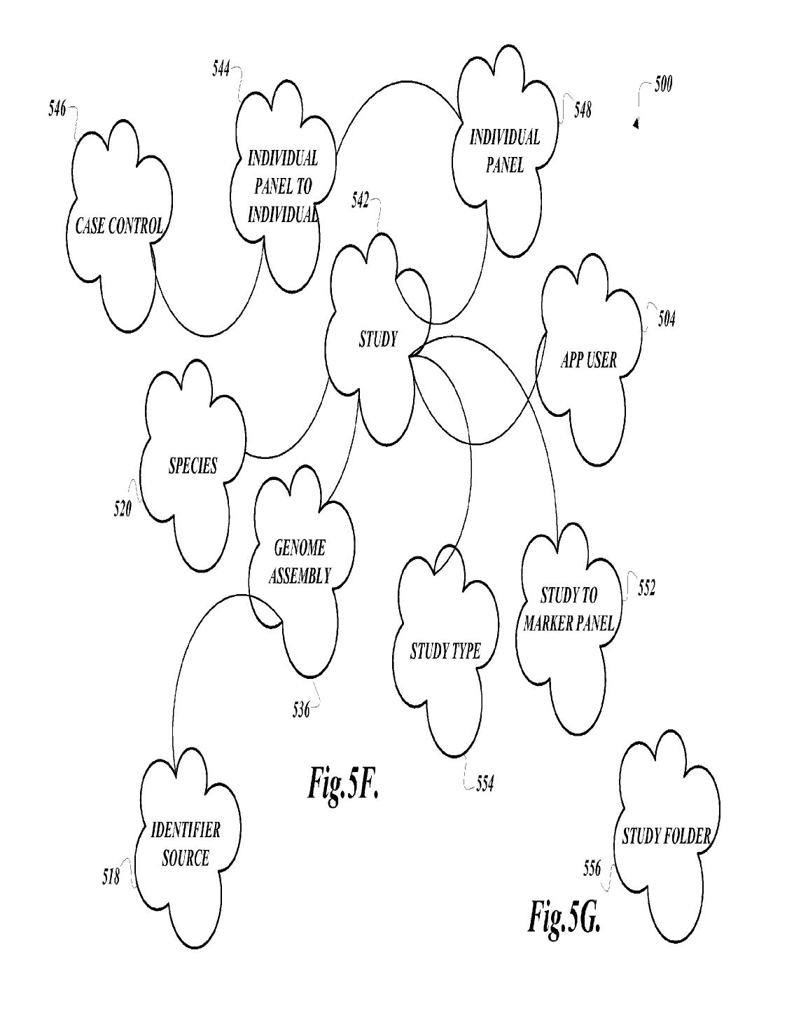

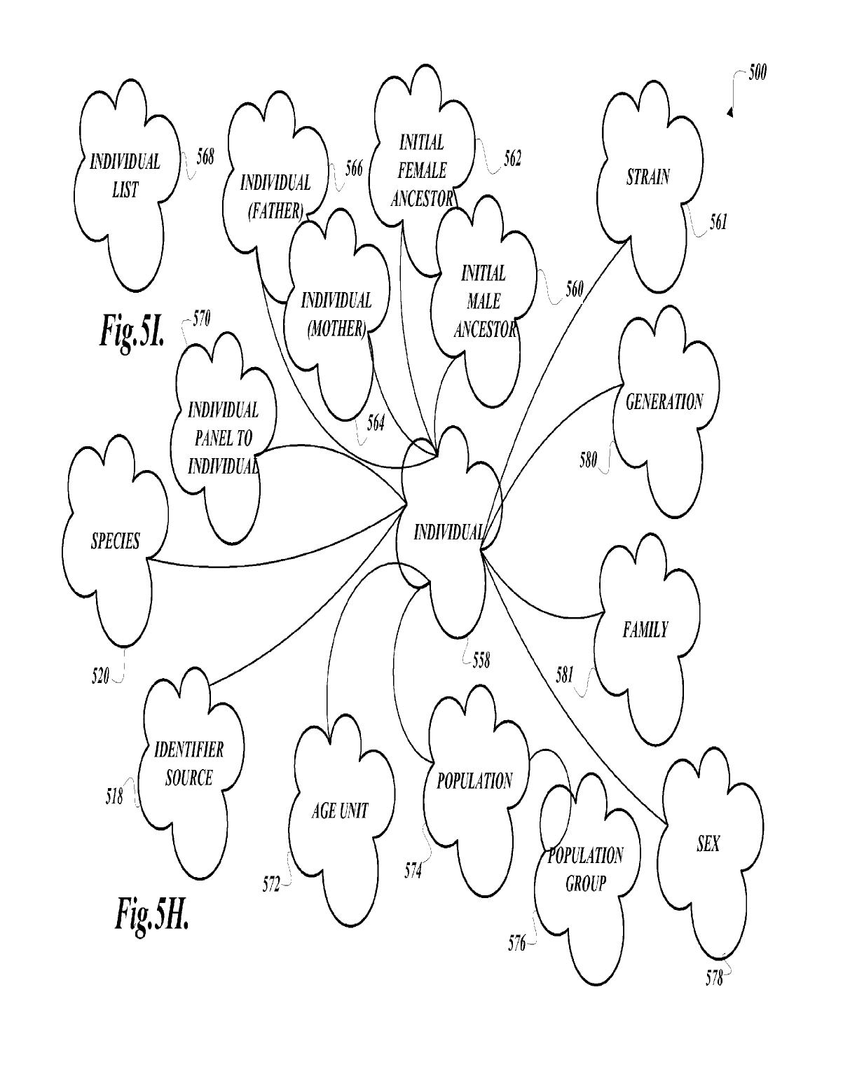

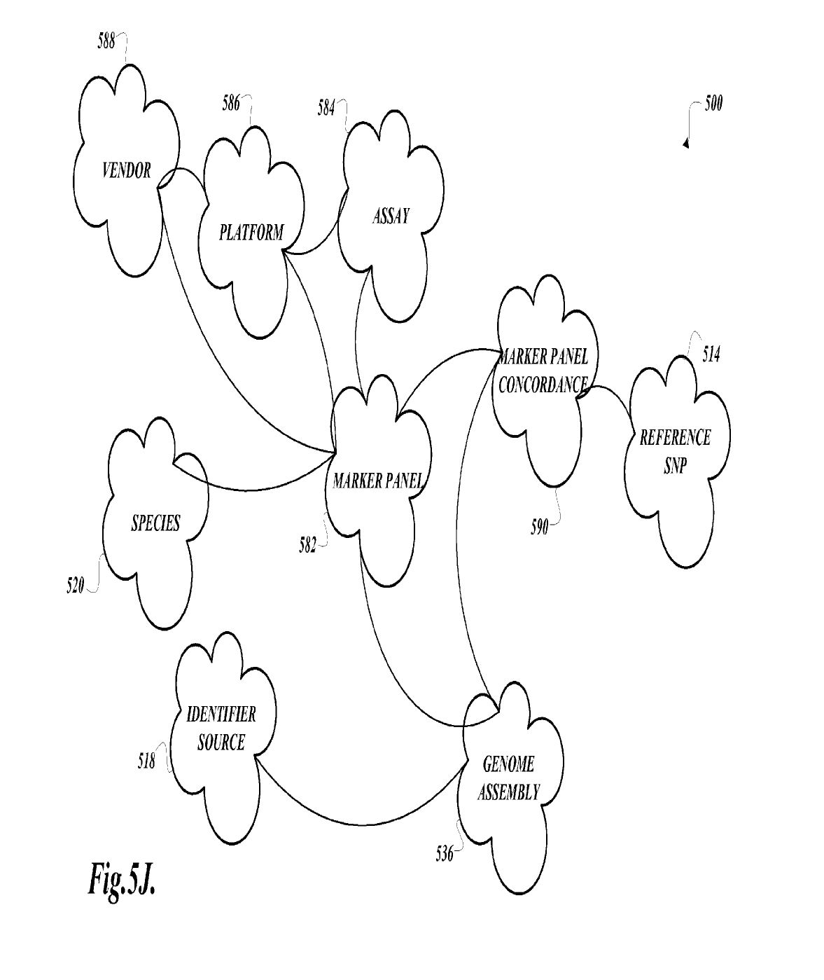

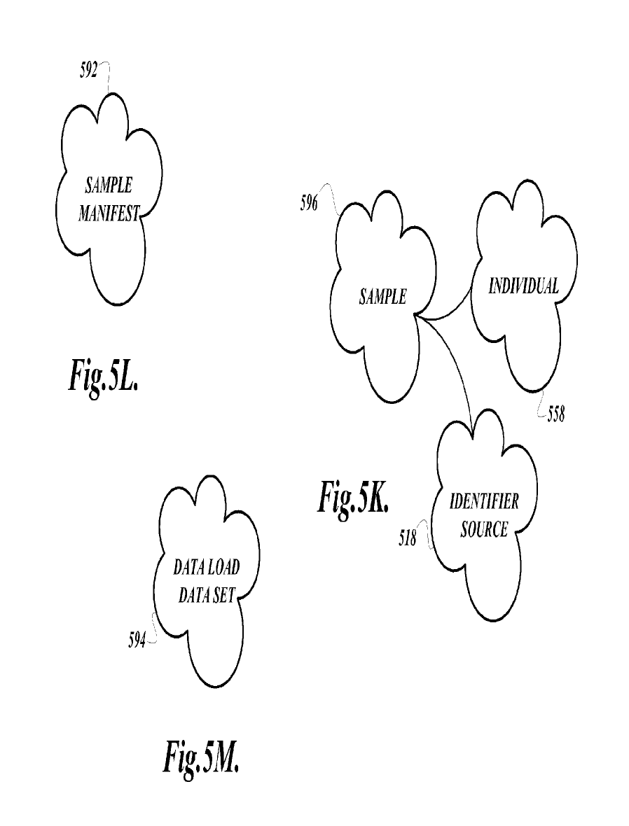

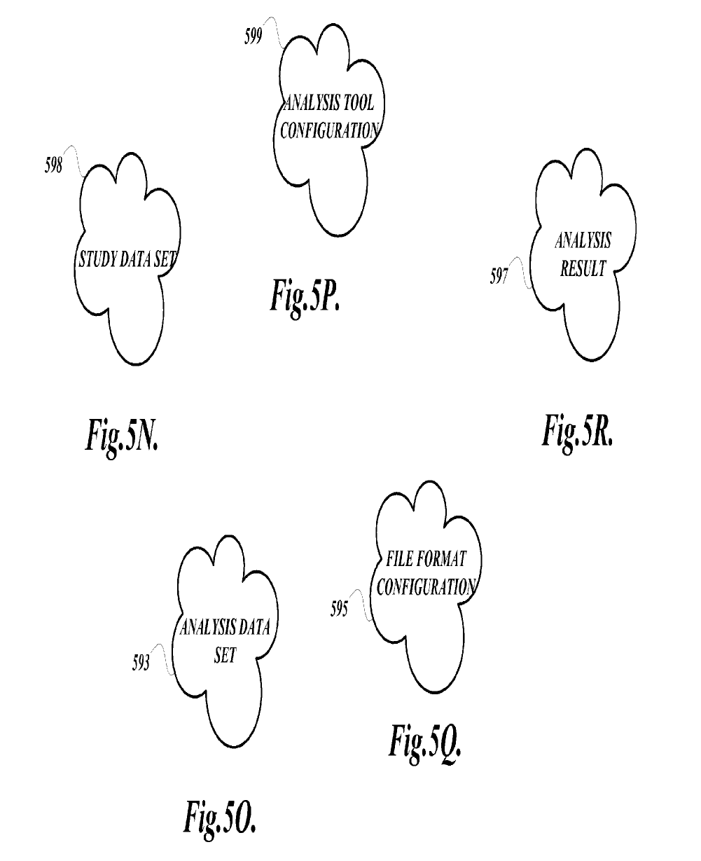

FIGS. 5A-5R illustrate data structure diagrams that introduce data abstractions that the integrated genomic system 102 uses to manage and organize information around genotyping data sets and data analysis. For clarity purposes, each data structure is represented by a cloud symbol, which is a generalized category that describes a group of more specific items, called data objects. In various embodiments of the present invention, these classes are used to represent a collection of database tables collectively referenced as a schema 500. Each database table is basically a file composed of records, each containing fields together with a set of operations for searching, sorting, recombining, and performing other database functions, such as create, read, update, and delete. Each record of database tables has a structure, which is characterized by rows and columns with data occupying or potentially occupying each cell formed by a row-column intersection. Information regarding markers, individuals, and studies therefore has a data structure for describing such information. Many pieces of information are stored by the database besides those mentioned hereinabove, such as chromosome, gene, genome assembly, and so on. Only a portion of data structures is illustrated by the schema 500.

Data objects, which are instantiations of data structures, to be discussed herein below are organized into a workspace 502. Within the workspace 502, each instance of a data structure has an associated access control list and revision information. The access control list specifies a list of system users (researchers) who have read and read-write access to each data object. The revision information maintains for each object a comprehensive set of auditing records identifying when a modification was done to an object and by whom.

As data objects get created in the integrated genomic system 102, logical dependency among them may arise. For example, a specific analysis result depends on an analysis tool configuration that was used to create the analysis result as well as any data object that was passed as input data into the analysis tool. In order to achieve reproducibility of results, the integrated genomic system 102 maintains for each data object a set of objects it is dependent on. In this way, the integrated genomic system 102 is able to identify for any given data object whether the object is still consistent with the objects it depends on by comparing its last modification time to the last modification times of those objects.

As discussed, a majority of the data objects are organized into a workspace hierarchy, which is a conceptual organization of overall setup data stored in the integrated genomic system 102 for the purpose of intuitive presentation to a user (researcher). One example of such conceptual organization is reference data. Reference data includes gene, marker, general assembly, individual, analysis tool configuration, file format configuration, and marker panel. The genome assembly includes chromosome and location. The conceptual hierarchy of project data includes project data. Under project data is a study. In a study, there are study data set, data load data set, individual panel, individual list, marker list, gene list, and analysis result. Under study data set, an analysis data set is available. Under data load data set, a sample manifest is available. These data object types will be further expounded herein below in connection with FIGS. 5A-5R.

Each data structure has a number of fields. Information regarding an individual, a sample, a marker, or a gene is stored in these fields that form the columns of a database table with information occupying the rows. These data structures facilitate searches by using data in specified columns in one database table to find additional data in another database table. Information is matched from a field in one database table with information in a corresponding field of another database table to produce results for queries that combine requested data from both database tables. For example, data structure REFERENCE_SNP 514 contains SNP_TYPE_ID field and data structure SNP_TYPE 524 contains a number of fields including SNP_TYPE_ID field. A database, such as the integrated genomic database server 214, can match the SNP_TYPE_ID fields in the two data structures 514, 524, to find information (e.g., all SNPs of a particular type). In other words, the integrated genomic database server 214 uses matching values in two tables to relay information in one to information in the other.

FIG. 5A illustrates the schema 500 where a data structure APP_USER 504 participates within a workspace represented by the data structure workspace 502. The data structure APP_USER 504 includes a number of fields, such as: user identification, which is a system-generated unique key; a last name, which is the last name of the user; a user name, which is a unique name of the user; a suffix, which is the suffix name for the user; first name, which is the first name of the user; middle name, which is the middle name of the user; e-mail, which is the e-mail address of the user; address, which is the physical address of the user; city, which is the city the user lives in; state, which is the state the user lives in; country, which is the country the user lives in; zip, which is the zip code the user lives in; phone, which is a phone number of the user; fax, which is a facsimile communication number of the user; and password status, which is a password status connected with the user.

The abstract data structure WORKSPACE 502 can be conceptually organized by an abstract data structure biological annotation 508, data abstraction experimental data 506, and data abstraction data analysis 510. FIGS. 5B-5E illustrate other data structures connected with the data abstraction biological annotation 508. FIGS. 5F-5M illustrate data structures connected with the data abstraction experimental data 506. FIGS. 5N-5R illustrate data structures connected with the data abstraction data analysis 510.

The data structure REFERENCE_SNP 514 represents each SNP in the integrated genomic system 102. See FIG. 5B. An SNP is a DNA sequence variation occurring when a single nucleotide, A, T, C, or G in the genome (or other shared sequence) differs between members of a species (between paired chromosomes in an individual). The data structure REFERENCE_SNP 514 can be associated with a data structure abstraction marker 512, which represents a genetic marker using a known DNA sequence that can be identified via a symbol assay. A genetic marker can be a short DNA sequence, such as a sequence surrounding a single base-paired chain (single nucleotide polymorphism) or a long one, like microsatellites. For each marker, the integrated genomic system 102 captures a set of genomic alleles, which is a set of possible variations that can be observed in an organism. The data structure REFERENCE_SNP 514 includes: field SNP_ID, which is a unique key generated by the integrated genomic system 102; field SNP_COMMENTS, which are user entered comments about the SNP; field GENOMIC_ALLELES, which are the allele values of an SNP; a field SNP_TYPE_ID, which is a foreign key to a data structure SNP_TYPE, and which is symbolized by a line emanating from the data structure REFERENCE_SNP 514 and terminating at a data structure SNP_TYPE; field SNP_FUNCTION_ID, which is a foreign key to a data structure SNP_FUNCTION, and which is symbolized by a line emanating from the data structure REFERENCE_SNP 514 and terminating at a data structure SNP_FUNCTION; field SPECIES_ID, which is a foreign key to a data structure SPECIES, and which is symbolized by a line emanating from the data structure REFERENCE_SNP 514 and terminating at a data structure SPECIES; field DELETED_IN_BUILDNUMBER, which is a foreign key to a data structure GENOME_ASSEMBLY, which tracks which genome assembly from which an SNP has been removed, and which is symbolized by a line emanating from the data structure REFERENCE_SNP 514 and terminating at a data structure GENOME_ASSEMBLY; and field LOAD_COMMENTS, which represents notes about the original load of the SNP.

The data structure SNP_TYPE represents the type of SNP that includes: field SNP_TYPE_ID, which is uniquely generated by the integrated genomic system; field NAME, which is a user specified name for the database records; and field DESCRIPTION, which is a user specified description for the record. A structure SNP_FUNCTION 522 represents function attributes of an SNP, and includes field SNP_FUNCTION_ID, which is uniquely generated by the integrated genomic system 102; field NAME, which is a user specified name for the record; and field DESCRIPTION, which is a user specified description for the record. A data structure SPECIES 520 represents valid species types of the integrated genomic system and includes: field SPECIES_ID, which is uniquely generated by the integrated genomic system; field NAME, which is a user specified name for the record; and field DESCRIPTION, which is a user specified description for the record.

A data structure GENOME_ASSEMBLY 516 represents a genome build in the integrated genomic system 102 and includes: field GENOME_ASSEMBLY_ID, which is uniquely generated by the integrated genomic system; field IDENTIFIER, which is a user entered identifier for the build; field IDENTIFIER_VERSION, which tracks the version of the identifier; field IDENTIFIER_SOURCE_IDNUMBER, which is a foreign key to a data structure IDENTIFIER_SOURCE for identifying the source of the IDENTIFIER field, and which is symbolized by a line emanating from the data structure GENOME_ASSEMBLY 516 and terminating at a data structure IDENTIFIER_SOURCE; field CREATED_BY, which is a user who first created the record; a field CREATED_DATE, which is a date the record was created; field MODIFIED_BY, which is a user who last modified the record; and field MODIFIED_DATE, which is the date the record was last modified. The data structure GENOME_ASSEMBLY 516 represents a reconstruction, for a specific organism, of the overall DNA sequence for each chromosome, which is assembled from experimentally gained sequencing information or fragments of the organism's DNA. The result of the process depends on the specifics of the DNA fragments used as input into the reconstruction process and the computational method used. With improvements in technology, new and improved genomic assemblies are created for a single organism over time. In particular, the genome assembly identifies the list of chromosomes that constitute the genome of an organism and assigns a specific location that is a chromosome and nucleotide base-pair interval to each marker and each gene.

A data structure IDENTIFIER_SOURCE 518 represents sources used by the integrated genomic system 102 and includes: field IDENTIFIER_SOURCE_ID, which is uniquely generated by the integrated genomic system; field NAME, which is a user specified name for the record; field DESCRIPTION, which is a user specified description for the record; field URL, which is the full uniform resource locator of the identifier source; and field INSTALINK_BASE_URL, which is a uniform resource locator used for query searches.

FIG. 5D illustrates a data structure GENE 528, which represents a locatable region of the genomic sequence corresponding to a unit of inheritance, which is associated with regulatory regions, transcribe regions, and/or other functional sequence regions, and includes: field GENE_ID, which is a system generated unique key; field NAME, which is a name of the gene; field DESCRIPTION, which is a description of the gene; field SYMBOL, which is the gene symbol; field IDENTIFIER, which is a user entered identifier for the gene; field IDENTIFIER_VERSION, which tracks the version of the identifier; field IDENTIFIER_SOURCE_IDNUMBER, which is a foreign key to the data structure IDENTIFIER_SOURCE 518 for identifying the source of the IDENTIFIER field and is indicated visually by a line emanating from the data structure GENE 528 terminating at the data structure IDENTIFIER_SOURCE 518; field SUMMARY, which is a PubMed summary; field SPECIES_ID, which is a foreign key to the data structure SPECIES 520 and is symbolized by a line emanating from the data structure GENE 528 terminating at the data structure SPECIES 520; field GENE_TYPE_ID, which is a foreign key to a data structure GENE_TYPE 530 for identifying a gene type and is symbolized by a line emanating from the data structure GENE 528 terminating at the data structure GENE-TYPE 530; and field ALIAS, which describes aliases for the gene.

The data structure GENE_TYPE 530 represents various types of genes and includes: field GENE_TYPE_ID, which is a system generated unique key; field NAME, which is a user specified name for the record; and field DESCRIPTION, which is a user specified description for the record.

A data structure GENE_LOCATION 534 represents locations of genes between different genome assembly builds and includes: field GENE_ID, which is a foreign key to the data structure GENE 528 and is symbolized by a line emanating from the data structure GENE_LOCATION 534 and terminating at the data structure GENE 528; field GENOME_ASSEMBLY ID, which is a foreign key to the data structure GENOME_ASSEMBLY 536 and is symbolized by a line emanating from the data structure GENOME_LOCATION 534 and terminating at the data structure GENOME_ASSEMBLY 536; field CHROMOSOME_ID, which represents a foreign key to a data structure CHROMOSOME 540 and is symbolized by a line emanating from the data structure GENE_LOCATION 534 and terminating at the data structure CHROMOSOME 540; field START_POSITION, which is a start position of the gene; field END_POSITION, which is the end position of the gene; and field STRAND, which is the strand or orientation of the gene on the chromosome.

The data structure CHROMOSOME 540 represents data regarding large marker molecules of DNA and constitutes a physical organized form of DNA in a cell and includes: field CHROMOSOME_ID, which is a system generated unique key; field NAME, which is a user specified name for the record; field DESCRIPTION, which is a user specified description for the record; field CHROMOSOME_NUMBER, which is the number of the chromosome; and field SPECIES_ID, which is a foreign key to the data structure SPECIES 520 and is symbolized by a line emanating from the data structure CHROMOSOME 540 and terminating at the data structure SPECIES 520.

A data structure CHROMOSOME_LOCATION 538 represents locations of chromosomes between different genome assembly builds and includes: field CHROMOSOME_ID, which is a foreign key to the data structure CHROMOSOME 540 and is symbolized by a line emanating from the data structure CHROMOSOME_LOCATION 538 and terminating at the data structure CHROMOSOME 540; field GENOME_ASSEMBLY_ID, which is a foreign key to the data structure GENOME_ASSEMBLY 536 and is symbolized by a line emanating from the data structure CHROMOSOME_LOCATION 538 and terminating at the data structure GENOME_ASSEMBLY 536; field START_POSITION, which is a start position of the chromosome; and field END_POSITION, which is an end position of the chromosome.

FIG. 5E illustrates a data structure GENE LIST, which represents an unordered collection of genes such as those described by the data structure GENE 528. FIG. 5C illustrates a data structure MARKER LIST 526, which represents an unordered collection of genetic markers such as those described by the data structure REFERENCE_SNP 514.

FIG. 5F illustrates a data structure STUDY 542, which represents a population of individuals being genotyped and analyzed as a whole to pursue desired statistical results alongside information about a specific assay used to measure genetic variations for a set of markers across this population of individuals. The data structure STUDY 542 includes: field STUDY_ID, which is a system generated unique key; FIELD NAME, which is a user-specified name for the record; FIELD DESCRIPTION, which is a user-specified description for the record; FIELD OWNED_BY_USER_ID, which is a foreign key to a data structure, APP_USER 550, and is symbolized by a line emanating from the data structure STUDY 542 and terminating at the data structure APP_USER 550; field STUDY_TYPE_ID, which is a foreign key to a data structure STUDY_TYPE 554 and is symbolized by a line emanating from the data structure STUDY 542 and terminating at the data structure STUDY_TYPE 554; field GENOME_ASSEMBLY_ID, which is a foreign key to the data structure GENOME_ASSEMBLY 536 and is symbolized by a line emanating from the data structure STUDY 542 and terminating at the data structure GENOME_ASSEMBLY 536; field SPECIES_ID, which is a foreign key to the data structure SPECIES 520, and is symbolized by a line emanating from the data structure STUDY 542 terminating at the data structure SPECIES 520; field POWER, which represents the scale of the study indicating the number of markers, the number of individuals, the number of samples, and so on; field CREATED_BY, which is a user who first created the record; field CREATED_DATE, which is the date the record was created; field MODIFIED_BY, which is a user who last modified the record; field MODIFIED_DATE, which is the date the record was last modified; field PARENT_FOLDER_PATH, which is a server path to the parent file of the study; field PROPOSED_ANALYSIS_PATH, which is a server path to additional documents relating to the analysis of the study; and field STUDY_ATTACHMENTS_PATH, which is a server path to any additional documents relating to the study.

The data structure STUDY_TYPE 554 represents the possible study types a study can be and includes: field STUDY_TYPE_ID, which is a system-generated unique key; field NAME, which is a user-specified name for the record; and FIELD DESCRIPTION, which is a user-specified description for the record. A data structure STUDY_TO_MARKER_PANEL 552 represents a mapping between marker panels that are attached to a study. A marker is explained herein below. The data structure STUDY_TO_MARKER_PANEL 552 includes: field STUDY_ID, which is a foreign key to the data structure STUDY 542, and is symbolized by a line emanating from the data structure STUDY_TO_MARKER_PANEL 552 terminating at the data structure STUDY 542; and field MARKER_PANEL_ID, which is a foreign key to the data structure MARKER_PANEL 582.

A data structure INDIVIDUAL_PANEL 548 represents a population of individuals participating in a study. The individual panel can group the overall set of individuals into subpanels and subpopulations based on the specific design of the study as represented by the data structure STUDY 542. For example, in a case versus control study, the individual panel might identify individuals as belonging to a group of cases versus the control group. In a family-based linkage study, the individual panel might group the participating individuals into their families. The data structure INDIVIDUAL_PANEL 548 includes: field INDIVIDUAL_PANEL_ID, which is a system-generated unique key; field NAME, which is a user-specified name for the record; field DESCRIPTION, which is a user-specified description for the record; field STUDY_ID, which is a foreign key to the data structure STUDY 542 and is symbolized by a line emanating from the data structure INDIVIDUAL_PANEL 548 and terminating at the data structure STUDY 542; field PARAMETERS, which stores filters for the individual panels; field CREATED_BY, which is the user who first created the record; field CREATED_DATE, which is the date the record was created; field MODIFIED_BY, which is the user who last modified the record; and field MODIFIED_DATE, which is the date the record was last modified.

A data structure INDIVIDUAL_PANEL_TO_INDIVIDUAL 544 represents a linkage between individual panels, such as those represented by the data structure INDIVIDUAL_PANEL 548, and the individuals assigned to an individual panel. The data structure INDIVIDUAL_PANEL_TO_INDIVIDUAL 544 includes: field INDIVIDUAL_PANEL_ID, which is a foreign key to the data structure INDIVIDUAL_PANEL 548 and which is symbolized by a line emanating from the data structure INDIVIDUAL_PANEL 548 terminating at the data structure INDIVIDUAL_PANEL_TO_INDIVIDUAL 544; field INDIVIDUAL_ID, which is a foreign key to the data structure INDIVIDUAL 558; and field CASE_CONTROL_ID, which is a foreign key to a data structure CASE_CONTROL 546 and which is represented by a line emanating from the data structure INDIVIDUAL_PANEL_TO_INDIVIDUAL 544 terminating at the data structure CASE_CONTROL 546.

The data structure CASE_CONTROL 546 stores different types of controls an individual can be assigned to. The data structure CASE_CONTROL 546 includes: field CASE_CONTROL_ID, which is a system-generated unique key; field NAME, which is a user-specified name for the record; and field DESCRIPTION, which is a user-specified description for the record.

FIG. 5G illustrates a data structure abstraction STUDY FOLDER 556, which is an organization element that can group zero or more studies or study folders. The set of study folders forms a strict hierarchy in the integrated genomic system 102.

FIG. 5H illustrates the data structure INDIVIDUAL 558 which represents and identifies a single living organism that is part of one or more studies. Typically, an individual designates a specific patient or a specific animal. The data structure INDIVIDUAL 558 includes: field INDIVIDUAL_ID, which is a system-generated unique key; field IDENTIFIER, which is a primary identifier assigned to the individual; field IDENTIFIER_SOURCE_ID, which is a foreign key to the data structure IDENTIFIER_SOURCE 518 and which is symbolized by a line emanating from the data structure INDIVIDUAL 558 terminating at the data structure IDENTIFIER_SOURCE 518; field EXTERNAL_IDENTIFIER, which is an external identifier assigned to the individual; field EXTERNAL_IDENTIFIER_SOURCE_ID, which is a foreign key to the data structure IDENTIFIER_SOURCE 518 and which is symbolized by a line emanating from the data structure INDIVIDUAL 558 terminating at the data structure IDENTIFIER_SOURCE 518; field DESCRIPTION, which is a user-specified description for the record; field FATHER_ID, which is a foreign key to the data structure INDIVIDUAL 566 which is an instantiation of the data structure INDIVIDUAL 558 and which is symbolized by a line emanating from the data structure INDIVIDUAL 558 terminating at the data structure INDIVIDUAL(FATHER) 566; field MOTHER_ID, which is a foreign key to the data structure INDIVIDUAL(MOTHER) 564, which is the mother of the individual, and which is an instantiation of the data structure INDIVIDUAL 558, and which is symbolized by a line emanating from the data structure INDIVIDUAL 558 terminating at the data structure INDIVIDUAL(MOTHER) 564; field FZERO_FEMALE_ID, which is a foreign key to an instantiation 562 of the data structure INDIVIDUAL 558, which represents the initial female ancestor of the individual, and which is symbolized by a line emanating from the data structure INDIVIDUAL 558 terminating at the data structure INITIAL FEMALE ANCESTOR 562; field FZERO_MALE_ID, which is a foreign key to an instantiation 560 of the data structure INDIVIDUAL 558 and which is symbolized by a line emanating from the data structure INDIVIDUAL 558 terminating at the data structure INITIAL MALE ANCESTOR 560; field FAMILY_ID, which is a foreign key to a data structure FAMILY 581 and which is symbolized by a line emanating from the data structure INDIVIDUAL 558 terminating at the data structure FAMILY 581; field DATE_OF_BIRTH, which is the birth date of the individual; field DATE_OF_SACRIFICE, which is the date of death of the individual; field AGE, which is the age of the individual; field AGE_UNIT_ID, which is the foreign key to a data structure AGE_UNIT 572 and which is symbolized by a line emanating from the data structure INDIVIDUAL 558 terminating at the data structure AGE_UNIT 572; field POPULATION_ID, which is a foreign key to a data structure POPULATION 574 and which is symbolized by a line emanating from the data structure INDIVIDUAL 558 terminating at the data structure POPULATION 574; field SPECIES_ID, which is a foreign key to the data structure SPECIES 520 and which is symbolized by a line emanating from the data structure INDIVIDUAL 558 terminating at the data structure SPECIES 520; field SEX_ID, which is a foreign key to the data structure SEX 578 and which is symbolized by a line emanating from the data structure INDIVIDUAL 558 terminating at the data structure SEX 578; field GENERATION_ID, which is a foreign key to the data structure GENERATION 580 and which is symbolized by a line emanating from the data structure INDIVIDUAL 558 terminating at the data structure GENERATION 580; field STRAIN_ID, which is a foreign key to the data structure STRAIN 561, and which is symbolized by a line emanating from the data structure INDIVIDUAL 558 terminating at the data structure STRAIN 561; field CREATED_BY, which is the user who first created the record; field CREATED_DATE, which is the date the record was created; field MODIFIED_BY, which is the user who last modified the record; field MODIFIED_DATE, which is the date the record was last modified.

The data structure FAMILY 581 stores data about family groupings and includes: field FAMILY_ID, which is a system-generated unique key; field NAME, which is a user-specified name for the record; and field DESCRIPTION, which is a user-specified description for the record. The data structure AGE_UNIT 572 is a lookup table that contains user-entered unit value such as days, weeks, months, and so on. The data structure AGE_UNIT 572 includes field AGE_UNIT_ID, which is a system-generated unique key; field NAME, which is a user-specified name for the record; and field DESCRIPTION, which is a user-specified description for the record.

The data structure POPULATION 574 provides information on the population an individual belongs to. The data structure POPULATION 574 includes: field POPULATION_ID, which is a system-generated unique key; field NAME, which is a user-specified name for the population; field DESCRIPTION, which is a user-specified description for the population; and field POPULATION_GROUP_ID, which is a foreign key to a data structure POPULATION_GROUP 576, and which is symbolized by a line emanating from the data structure POPULATION 574 terminating at the data structure POPULATION_GROUP 576.

The data structure POPULATION_GROUP 576 is a high level grouping of populations and includes: field POPULATION_GROUP_ID, which is a system-generated unique key; field NAME, which is a user-specified name for the population group; and field DESCRIPTION, which is a user specified description for the population group. The data structure SEX 578 stores the valid entries for sex and includes field SEX_ID, which is a system-generated unique key; field NAME, which is a user-specified name for the record; field DESCRIPTION, which is a user-specified description for the record.

The data structure GENERATION 580 stores the generation nomenclature of the individual. It includes: field GENERATION_ID, which is a system-generated unique key; field NAME, which is a user-specified name for the record; and field DESCRIPTION, which is a user-specified description for the record. The data structure STRAIN 561 stores the valid strain types and includes field STRAIN_ID, which is a system-generated unique key; field NAME, which is a user-specified name for the record; and field DESCRIPTION, which is a user-specified description for the record. FIG. 5I illustrates a data structure abstraction INDIVIDUAL LIST 568 which is an unordered collection of individuals represented by the data structure INDIVIDUAL 558.

A data structure MARKER_PANEL 582 is illustrated in FIG. 5J. The data structure represents a set of markers alongside a specific assay that can be used to determine their variations in a sample of DNA. For SNPs, the marker panel includes specific flanking sequences used to locate the marker within a sample of DNA alongside information from which of the two strands forming a chromosome a data point will be obtained by an assay. During loading of genotype data, this information can be used to validate incoming data and to automatically recode data against a strand that is indicative of a primary strand for that SNP in a reference database. The data structure MARKER_PANEL 582 includes: field MARKER_PANEL_ID, which is a system-generated unique key; field NAME, which is a user-specified name for the record; field DESCRIPTION, which is a user-specified description for the record; field PLATFORM_ID, which is a foreign key to a data structure PLATFORM 586 and is symbolized by a line emanating from the data structure MARKER_PANEL 582 terminating at the data structure PLATFORM 586; field ASSAY_ID, which is a foreign key to the data structure ASSAY 584 and which is symbolized by a line emanating from the data structure MARKER_PANEL 582 terminating at the data structure ASSAY 584; field VENDOR_ID, which is a foreign key to a data structure VENDOR 588, and which is symbolized by a line emanating from the data structure MARKER_PANEL 582 terminating at the data structure VENDOR 588; field VERSION, which is a version of the marker panel used for genotyping; field VENDOR_PART_NUMBER, which is a part number of the panel used for genotyping; field GENOME_ASSEMBLY_ID, which is a foreign key to the data structure GENOME_ASSEMBLY 536 and which is symbolized by a line emanating from the data structure MARKER_PANEL 582 terminating at the data structure GENOME_ASSEMBLY 536; field SPECIES_ID, which is a foreign key to the data structure SPECIES 520 and which is symbolized by a line emanating from the data structure MARKER_PANEL 582 terminating at the data structure SPECIES 520; field CREATED_BY, which is the user who first created the record; field CREATED_DATE, which is the date the record was created; field MODIFIED_BY, which is the user who last modified the record; and field MODIFIED_DATE, which is the date the record was last modified.

The data structure PLATFORM 586 includes: field PLATFORM_ID, which is a system-generated unique key; field NAME, which is a user-specified name for the platform; field DESCRIPTION, which is a user-specified description for the platform; and field VENDOR_ID, which is a foreign key to the data structure VENDOR 588 and which is symbolized by a line emanating from the data structure PLATFORM 586 terminating at the data structure VENDOR 588.

The data structure ASSAY 584 stores the assay types for a platform and includes: field ASSAY_ID, which is a system-generated unique key; field NAME, which is a user-specified name for the record; field DESCRIPTION, which is a user-specified description for the record; and field PLATFORM_ID, which is a foreign key to the data structure PLATFORM 586, and which is symbolized by a line emanating from the data structure ASSAY 584 terminating at the data structure PLATFORM 586. The data structure VENDOR 588 lists all the vendors in the integrated genomic system and includes field VENDOR_ID, which is a system-generated unique key; field NAME, which is a user-specified name for the record; and field DESCRIPTION, which is a user-specified description for the record.

FIG. 5K illustrates a data structure SAMPLE 596, which stores information about each sample from an individual and includes: field SAMPLE_ID, which is a system-generated unique key; field CODE, which is a user-specified code for the sample; field DESCRIPTION, which is a user-specified description for the sample; field INDIVIDUAL_ID, which is a foreign key to the data structure INDIVIDUAL 558 and which is symbolized by a line emanating from the data structure SAMPLE 596 terminating at the data structure INDIVIDUAL 558; and field IDENTIFIER_SOURCE_ID, which is a foreign key to the data structure IDENTIFIER_SOURCE 518 and which is symbolized by a line emanating from the data structure SAMPLE 596 terminating at the data structure IDENTIFIER_SOURCE 518.

FIG. 5L illustrates a data structure abstraction SAMPLE MANIFEST 592 which specifies a set of DNA samples whose genotypes will be or have been experimentally determined alongside mapping information that determines for each DNA sample the individual from which the sample originated.

FIG. 5M illustrates a data structure abstraction DATA LOAD DATA SET 594 which comprises a sample manifest, a reference to a marker panel, and for each combination of sample and marker from the sample manifest and marker panel, an associated set of alleles that have been experimentally determined for the sample and marker in the genotyping assay experiment. This set of alleles is also defined as the genotype call.

FIG. 5N illustrates a data structure abstraction STUDY DATA SET 598 which associates a genotype call to each individual and marker that are associated with a study. This association is constructed by reconciling genotype calls for samples across one or more data load data set. FIG. 5O illustrates a data structure abstraction ANALYSIS DATA SET 593 which represents a subset of a data study set by restricting the data shown to data points associated with an individual list and marker list. These individual lists and marker lists can be implicitly defined by cut off parameters on summary statistics associated with individual markers for the underlying study data set.

FIG. 5P illustrates a data structure abstraction ANALYSIS TOOL CONFIGURATION 599 which captures the information to parameterize the invocation of an external piece of software. This includes operating system-specific information about the program to be executed, the structure of its command line, and the format specification for command line argument values as well as necessary input and output files. Programs can be either platform-specific binary program executables, or they can be encoded as byte-code or scripted program text.

FIG. 5Q illustrates a data structure abstraction FILE FORMAT CONFIGURATION 595 which defines a mapping from an external file format from or to a data object that is part of the integrated genomic system 102. In particular, a data object is an individual, a sample, a marker, a gene, a matrix of genotyping calls, and analysis results. FIG. 5R illustrates a data structure abstraction ANALYSIS RESULT 597 which is numerical information associated with an individual, a sample, a marker, a gene, or a pair or triple of objects from this list.

Various embodiments of the present invention use two classes of storage. As primary data storage, the integrated genomic database server 214 is used to store reference information, which provides an organizational framework across individual studies. The integrated genomic database server 214 is also used in collaboration with a repository managed by the integrated genomic WEBDAV repository server 216, which organizes the eccentric information into a virtual file system tree. Various embodiments of the present invention store the following objects in the integrated genomic database server 214 connected with data structures: CHROMOSOME; GENE; GENE LIST; GENOME ASSEMBLY; INDIVIDUAL; INDIVIDUAL PANEL; MARKER; MARKER PANEL; SAMPLE MANIFEST; and STUDY. Various embodiments of the present invention store data objects in the integrated genomic WEBDAV repository server 216 for data structures: ANALYSIS RESULT; ANALYSIS TOOL CONFIGURATION; ANALYSIS DATA SET; DATA LOAD DATA SET; FILE FORMAT CONFIGURATION; INDIVIDUAL LIST; MARKER LIST; STUDY DATA SET; and STUDY FOLDER. Various embodiments of the present invention store data objects connected with certain data structures in HDF5 format, such as: DATA STRUCTURES ANALYSIS RESULT; DATA LOAD DATA SET; and STUDY DATA SET. HDF5 can store two primary objects, data sets and groups. A data set is essentially a multidimensional array of data elements and a group is a structure for organizing objects in an HDF5 file. Using these basic objects, the integrated genomic system 102 can create and store almost any kind of scientific data structure, such as images, arrays of vectors, and structure as well as unstructured grids.

Various embodiments of the present invention, in addition to the primary storage, use additional storage, such as a local tree managed by the integrated genomic client application tool sets on each client computer 202. Local copies are used for faster and direct access during data analysis and can contain draft versions of content that are currently under creation until they get published into the integrated genomic WEBDAV repository server 216. A local file tree managed by the job automation framework on each server computer 208 is additional storage that is used by the integrated genomic system 102. Similar to copies of the central repository located on the client computer 202, the server computer 208 maintains draft versions of content currently created or modified by automatic job execution until they get published into the integrated genomic WEBDAV repository server 216.

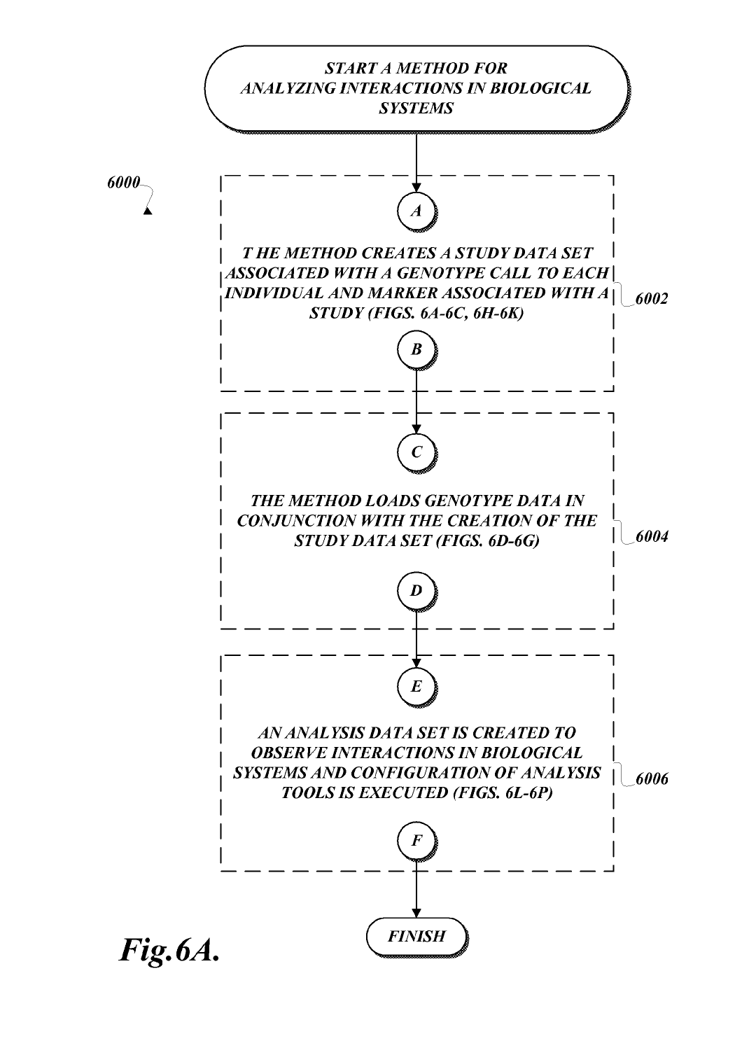

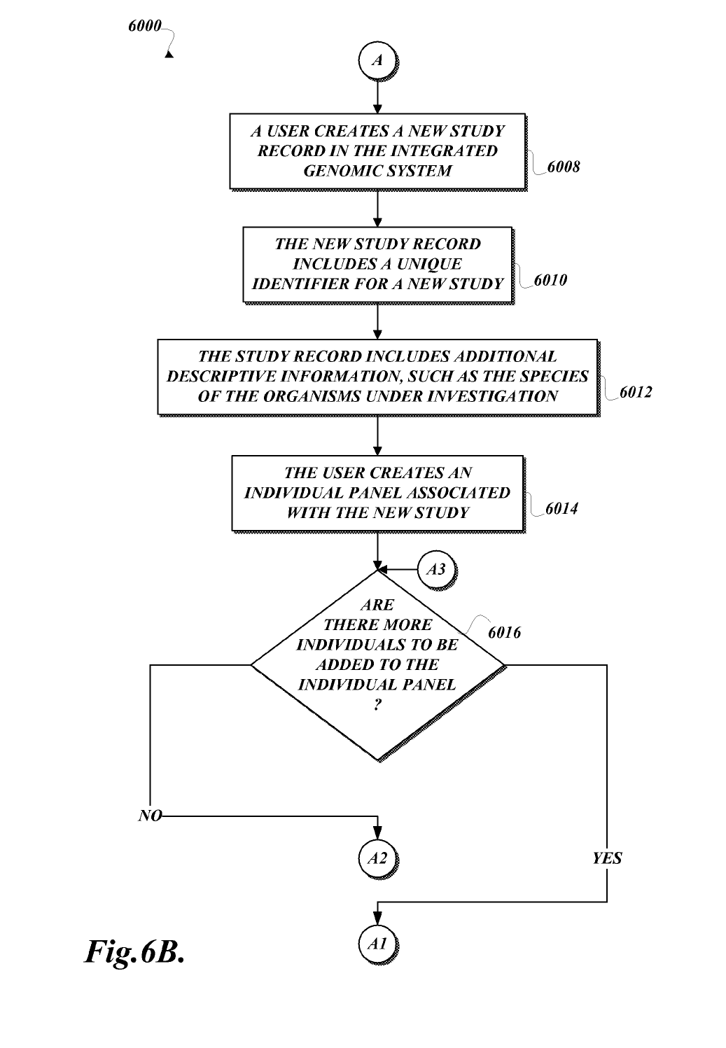

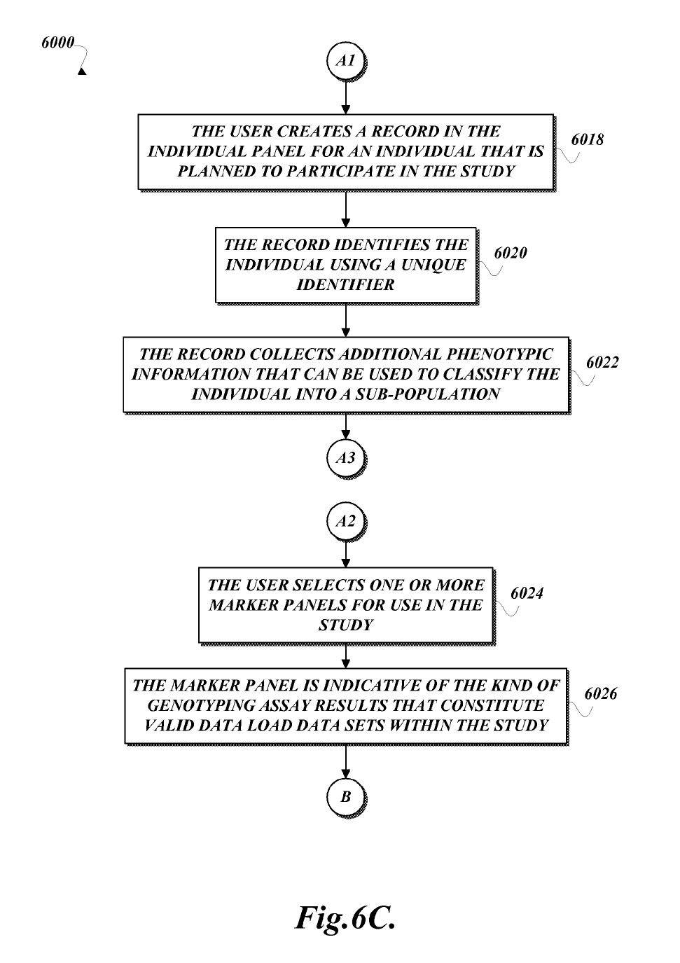

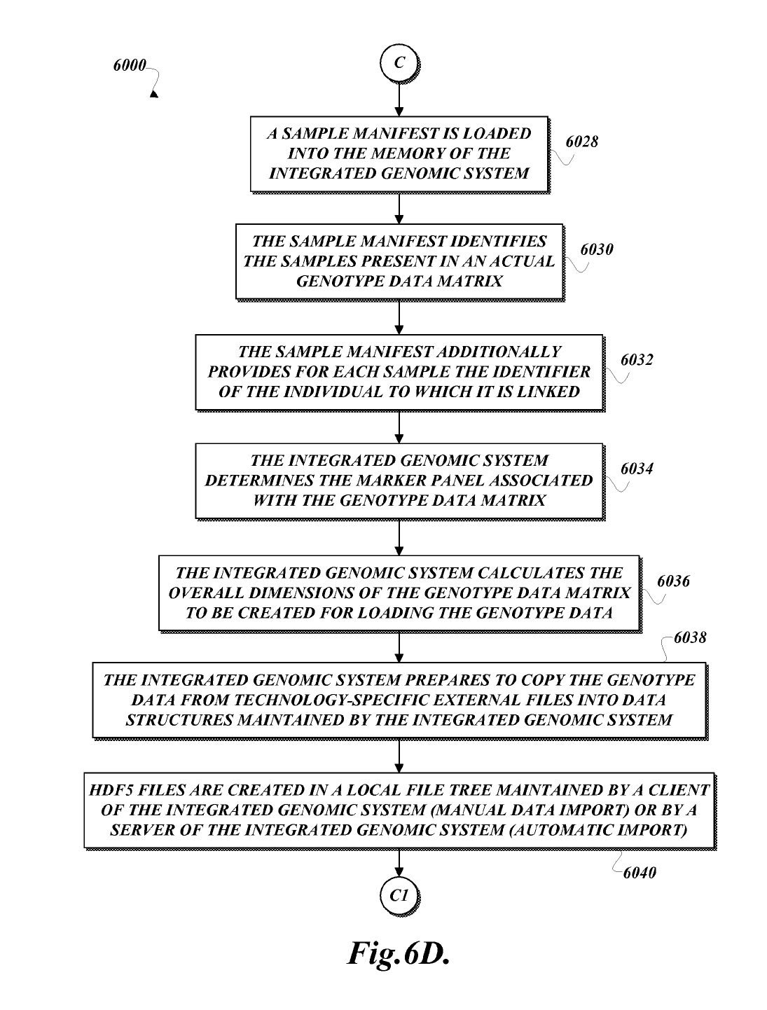

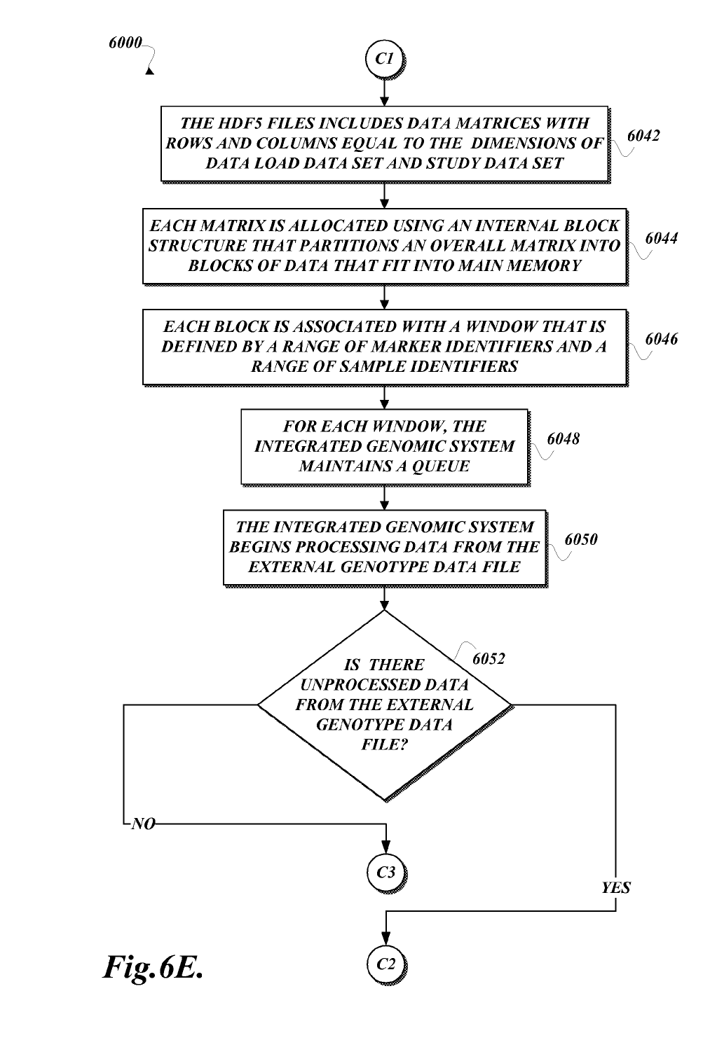

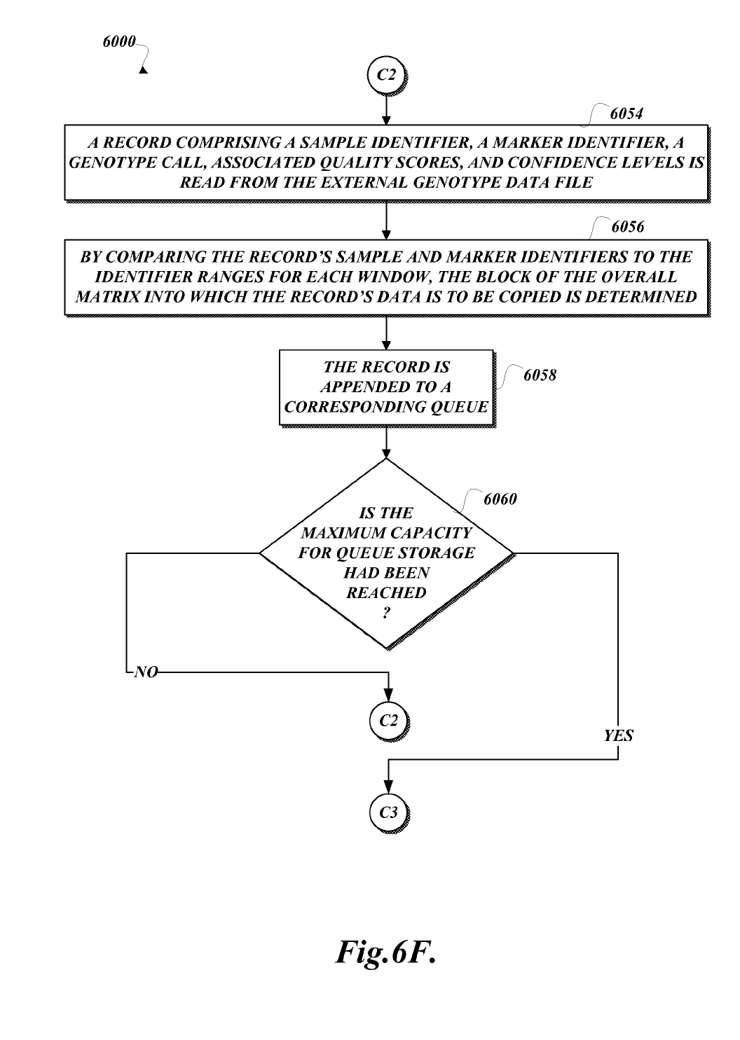

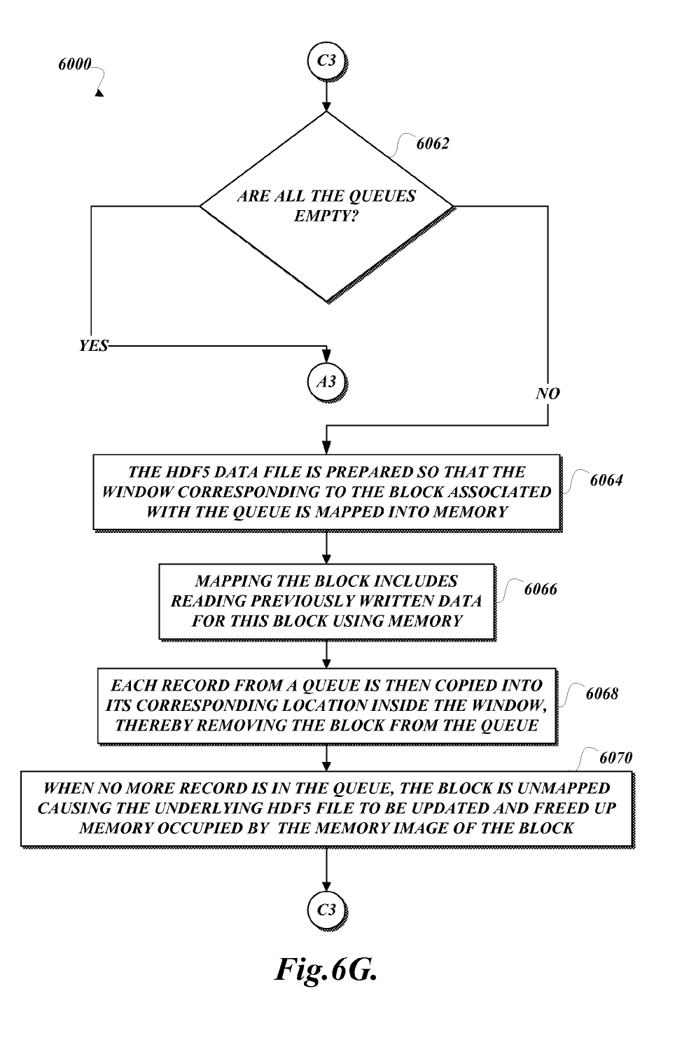

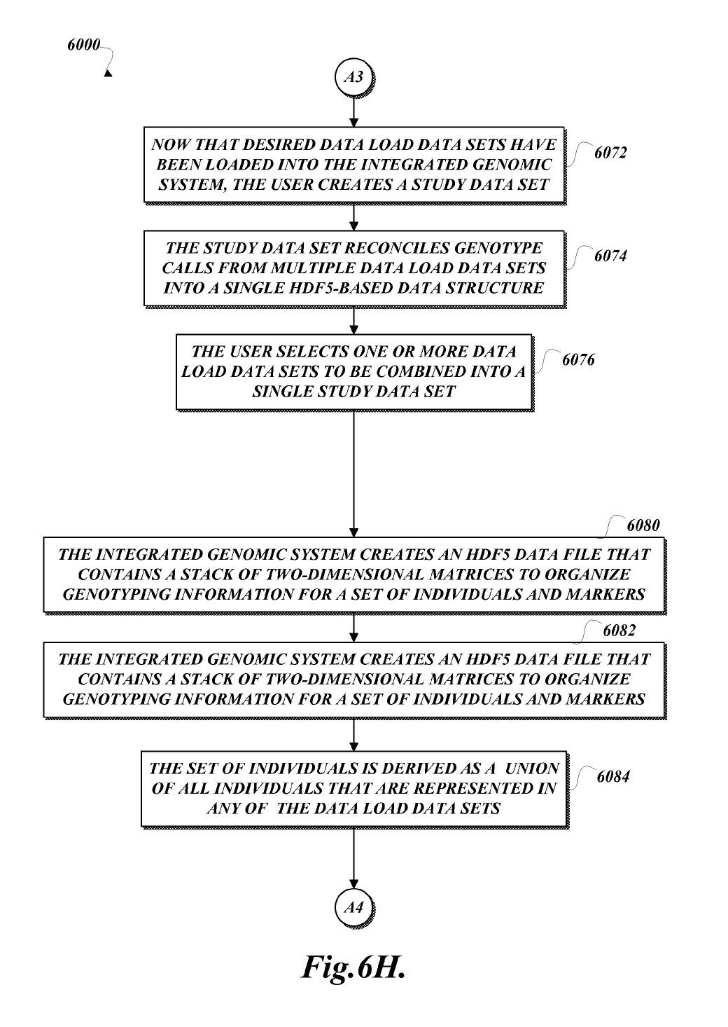

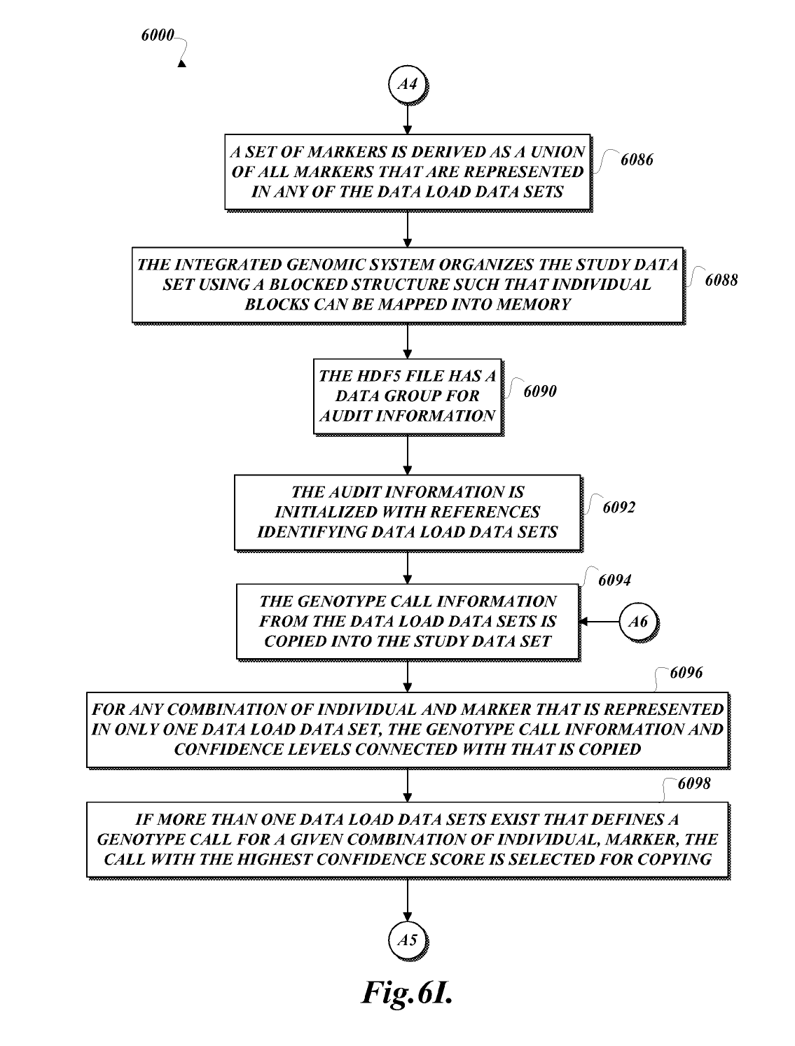

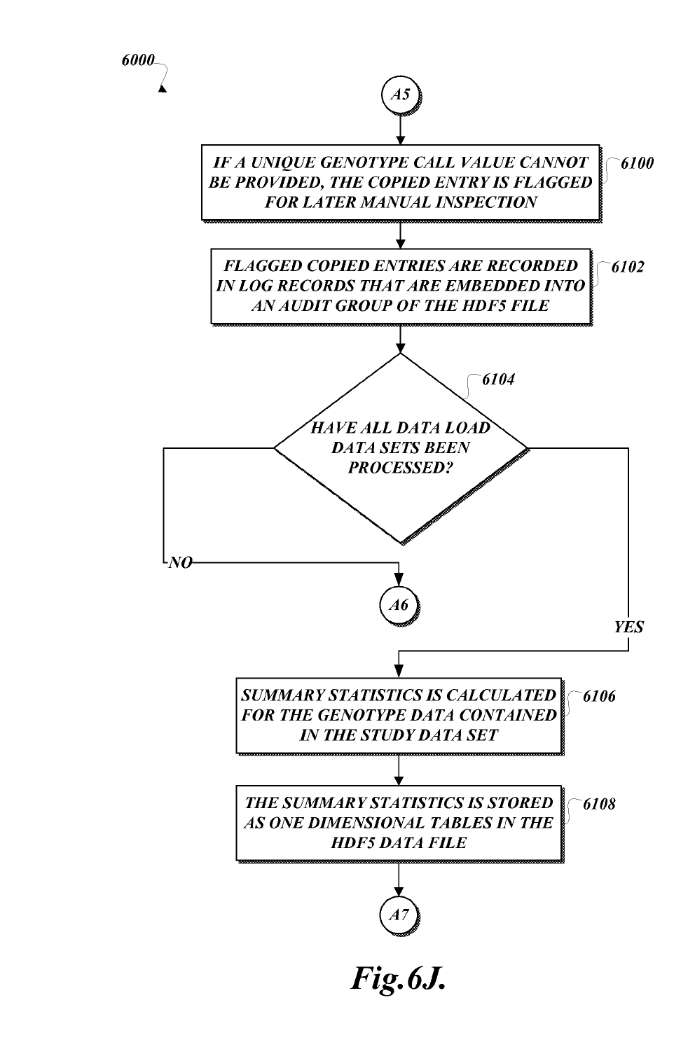

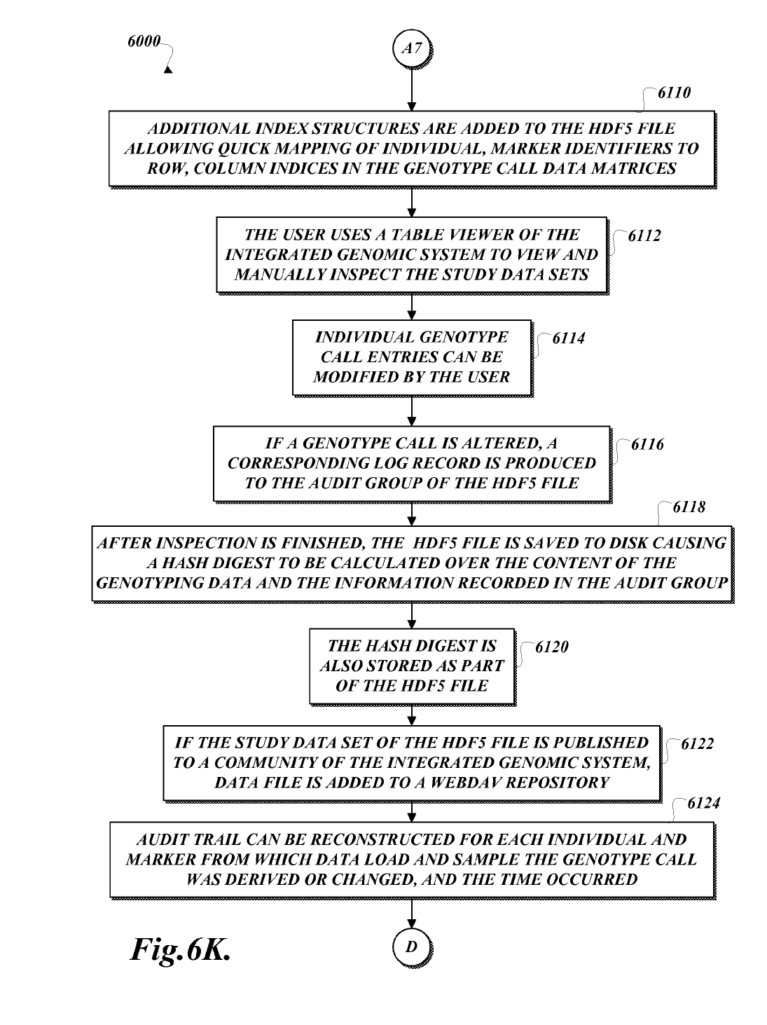

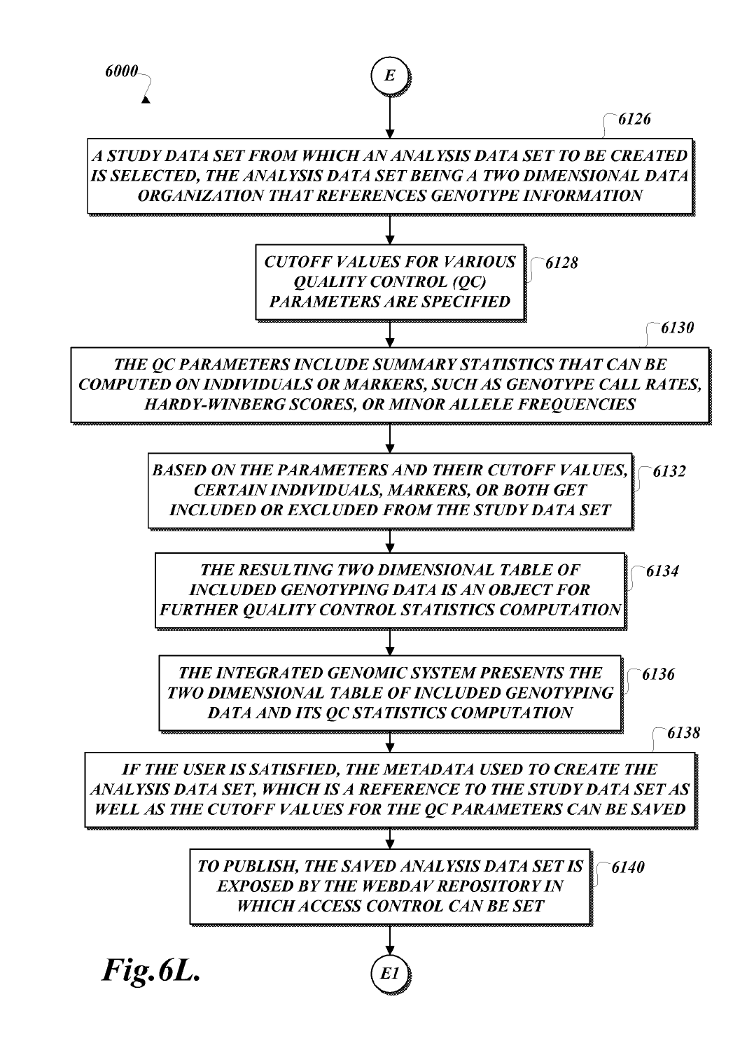

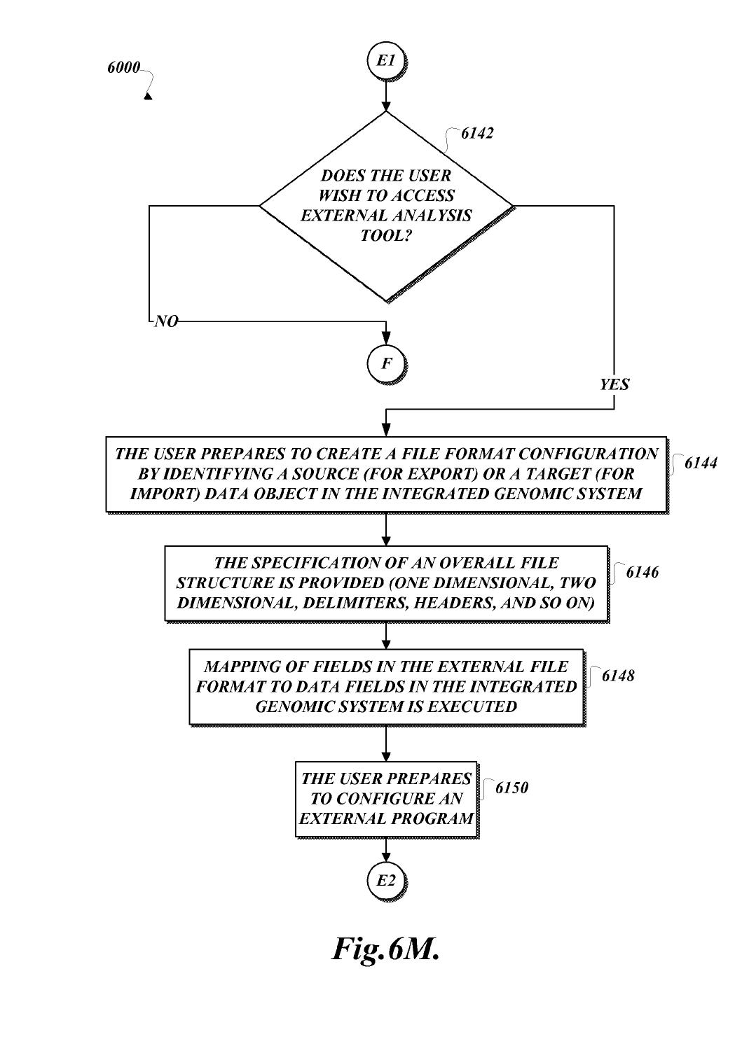

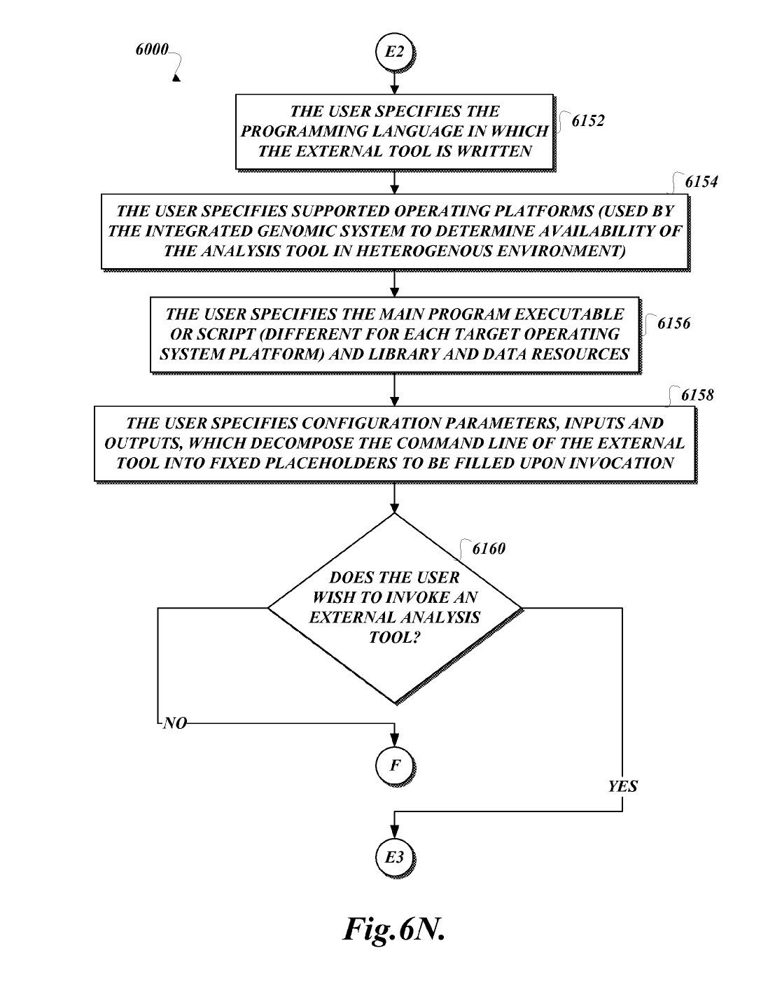

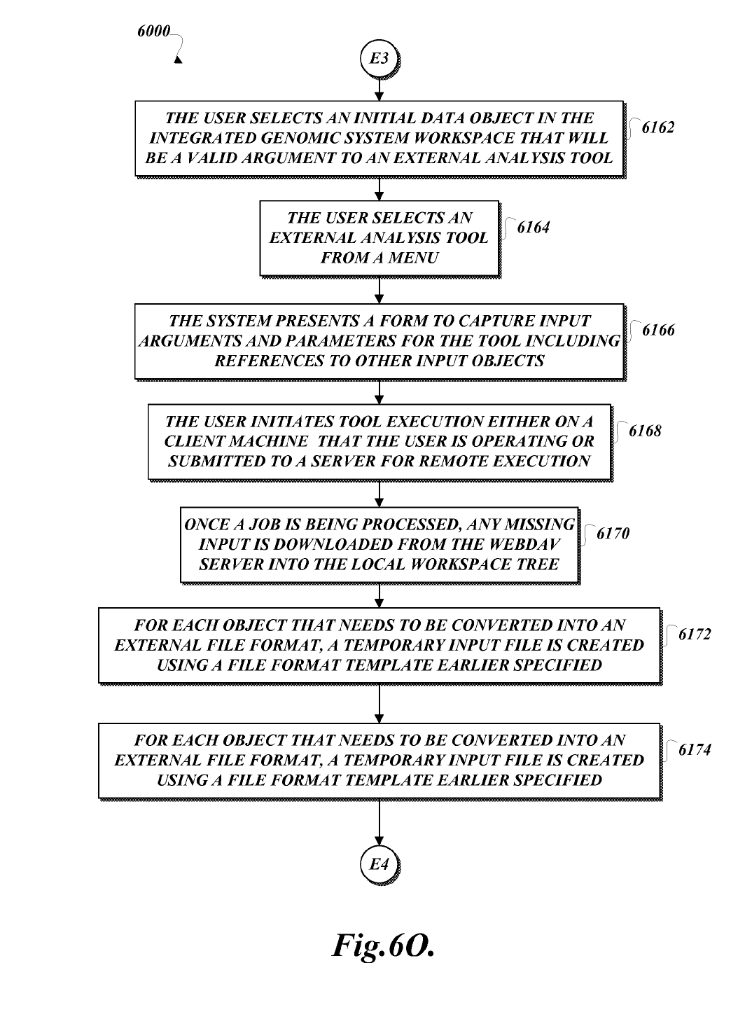

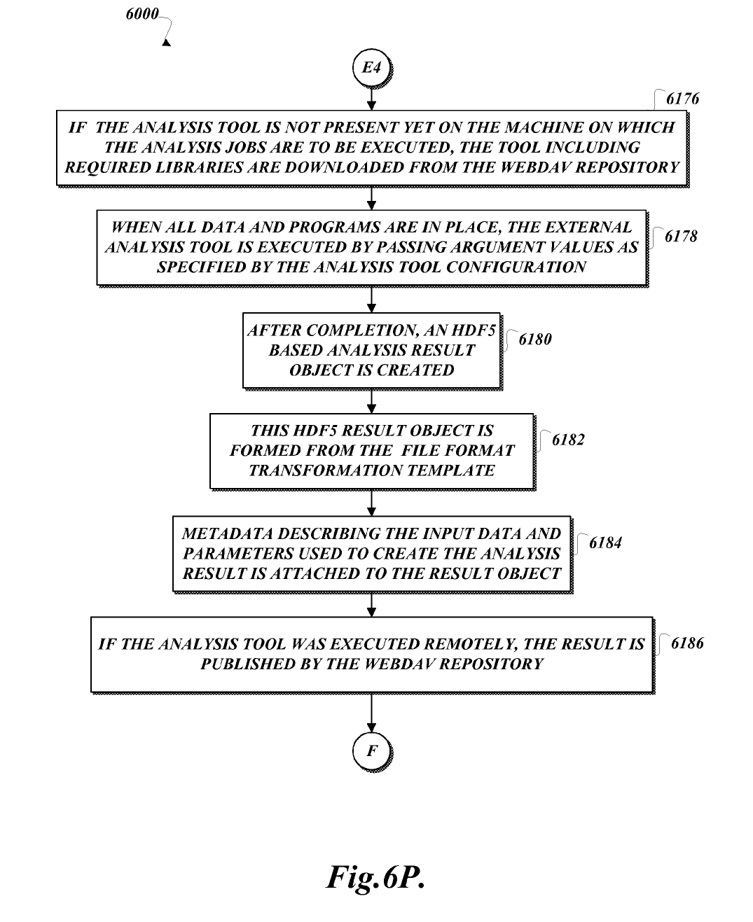

FIGS. 6A-6P illustrate a method 6000 for facilitating the analysis of interactions in biological systems. The method allows a researcher to use an integrated genomic system 102 to import external genotype data that may be in a multitude of formats from different platforms into common representation within the integrated genomic systems. Additionally, the researcher, through the integrated genomic system 102, can invoke external analysis tools in the genetics domain to analyze data exported by the integrated genomic system 102 and, in turn, produce analysis results, which can be re-imported back into the integrated genomic system 102 for the researcher to view and aid in his further genomic research. From a start block, the method 6000 proceeds to a set of method steps 6002, defined between a continuation terminal (“Terminal A”) and an exit terminal (“Terminal B”). The set of method steps 6002 describes creation of a study data set associated with a genotype call for each individual and marker associated with a study. As would be appreciated by one skilled in the art, the data structures described below are for merely illustrative purposes. Other data structures not mentioned here may be suitably used, and some of the mentioned data structures need not be used. Even the organization of the data structures can be changed from the organization discussed herein above and herein below.

From Terminal A (FIG. 6B), the method 6000 proceeds to block 6008 where a user creates a new study record in the integrated genomic system using the integrated genomic client application 206 on the client computer 202. At block 6010, the method causes the new study record to include a unique identifier for a new study. Next, at block 6012, the method causes the study record to include additional descriptive information, such as the species of the organisms under investigation. Using the integrated genomic client application 206, the user creates an individual panel associated with the new study at block 6014. The method 6000 proceeds to decision block 6016 where a test is performed to determine whether there are more individuals to be added to the individual panel. If the answer to the test at decision block 6016 is NO, the method 6000 proceeds to another continuation terminal (“Terminal A2”). Otherwise, if the answer to the test at decision block 6016 is YES, the method 6000 proceeds to yet another continuation terminal (“Terminal A1”).

From Terminal A1 (FIG. 6C), the user creates a record in the individual panel for an individual who is planned to participate in the study. See block 6018. At block 6020, the record identifies the individual using a unique identifier. Next, at block 6022, the record collects additional phenotypic information that can be used to classify the individual into a subpopulation. The method 6000 then proceeds to another continuation terminal (“Terminal A3”).

From Terminal A2 (FIG. 6C), the user selects one or more marker panels for use in the study at block 6024. Next, at block 6026, the marker panel is used by the method 6000 to indicate the kind of genotyping assay results that constitute validated low data sets within the study. The method then continues to the exit Terminal B. From Terminal B (FIG. 6A), the method 6000 proceeds to a set of method steps 6004 defined between a continuation terminal (“Terminal C”) and an exit terminal (“Terminal D”). The set of method steps 6004 describes the loading of genotype data in conjunction with the creation of the study data set within the integrated genomic system 102.

From Terminal C (FIG. 6D), the method 6000 proceeds to block 6028 where a sample manifest is loaded into the memory of the integrated genomic system. Next, at block 6030, the sample manifest identifies the samples present in an actual genotype data matrix. At block 6032, the sample manifest additionally provides for each sample the identifier of the individual to which it is linked. The integrated genomic system 102 determines the marker panel associated with the genotype data matrix. See block 6034. The method 6000 proceeds to block 6036 where the integrated genomic system 102 calculates the overall dimensions of the genotype data matrix to be created for loading the genotype data. At block 6038, the integrated genomic system prepares to copy the genotype data from technology-specific external files into data structures maintained by the integrated genomic system. HDF5 files are created in a local file tree maintained by a client of the integrated genomic system (manual data import) or by a server of the integrated genomic system (automatic import). See block 6040. The method 6000 then continues to another continuation terminal (“Terminal C1”).

From Terminal C1 (FIG. 6E), the method 6000 proceeds to block 6042 where the HDF5 files connected with data load data sets are processed to include data matrices with rows equal to the number of markers and columns equal to the numbers of samples. The HDF5 files connected with study data data sets are processed to include data matrices with rows equal to the number of markers and columns equal to the numbers of individuals. At block 6044, each matrix is allocated using an internal block structure that partitions an overall matrix into blocks of data that fit into main memory. At block 6046, each block is associated with a window that is defined by a range of marker identifiers and a range of sample identifiers. For each window, the integrated genomic system 102 maintains a queue. See block 6048. At block 6050, the integrated genomic system 102 begins processing data from the external genotype data file. At decision block 6052, a test is performed to determine whether there is unprocessed data from the external genotype data file. If the answer to the test at decision block 6052 is NO, the method continues to another continuation terminal (“Terminal C3”). Otherwise, if the answer to the test at decision block 6052 is YES, the method 6000 proceeds to another continuation terminal (“Terminal C2”).

From Terminal C2 (FIG. 6F), the method 6000 proceeds to block 6054 where a record comprising a sample identifier, a marker identifier, a genotype call, associated quality scores, and confidence levels is read from the external genotype data file. At block 6056, by comparing the record's sample and marker identifiers to the identifier ranges for each window, the block of the overall matrix into which the record's data is to be copied is determined. At block 6058, the record is appended to a corresponding queue. The method 6000 proceeds to decision block 6060 where a test is performed to determine whether the maximum capacity for queued storage has been reached. If the answer to the test at decision block 6060 is NO, the method continues to Terminal C2 and skips back to block 6054, where the above-identified processing steps are repeated. Otherwise, the answer to the test at decision block 6060 is YES, and the method proceeds to Terminal C3.

From Terminal C3 (FIG. 6G), the method 6000 proceeds to decision block 6062 where a test is performed to determine whether all the queues are empty. If the answer to the test at decision block 6062 is YES, the method continues to another continuation terminal (“Terminal A3”). If the answer to the test at decision block 6062 is NO, the method proceeds to block 6064 where the HDF5 data file is prepared so that the window corresponding to the block associated with the queue is mapped into memory. At block 6066, in mapping the block, the method reads previously written data for this block using memory. At block 6068, each record from a queue is then copied into its corresponding location inside the window, thereby removing the block from the queue. When no more records are in the queue, the block is unmapped, causing the underlying HDF5 file to be updated and freed-up memory occupied by the memory image of the block. See block 6070. The method then continues to Terminal C3 and skips back to decision block 6062 where the above-identified processing steps are repeated.

From Terminal A3 (FIG. 6H), the method 6000 proceeds to block 6072 where the user creates a study data set, now that desired data load data sets have been loaded into the integrated genomic system 102. At block 6074, the study data set reconciles general type calls from multiple data load data sets into a single HDF5-based data structure. The user selects one or more data load data sets to be combined into a single study data set at block 6076. The integrated genomic system creates an HDF5 data file that contains a stack of two-dimensional matrices to organize genotyping information for a set of individuals and markers. See block 6080. At block 6082, the integrated genomic system creates an HDF5 data file that contains a stack of two-dimensional matrices to organize genotyping information for a set of individuals and markers. At block 6084, the set of individuals is derived as a union of all individuals that are represented in any of the data load data sets. The method then continues to another continuation terminal (“Terminal A4”).

From Terminal A4 (FIG. 6I), the method 6000 proceeds to block 6086 where a set of markers is derived as a union of all markers that are represented in any of the data load data sets. At block 6088, the method 6000 organizes the study data set using a blocked structure such that individual blocks can be mapped into memory. The HDF5file has a data group for audit information. See block 6090. The audit information is initialized with references identifying data load data sets. See block 6092. At block 6094, the genotype call information from the data load data set is copied into the study data set. At block 6096, for any combination of individual and marker that is represented in only one data load data set, the genotype call information and confidence levels connected with that are copied. At block 6098, if more than one data load data set exists that defines a genotype call for a given combination of individual, marker, the call with the highest confidence score is selected for copying. The method 6000 then proceeds to another continuation terminal (“Terminal A5”).

From Terminal A5 (FIG. 6J), if a unique genotype call value cannot be provided, the copy eventually is flagged for later manual inspection. See block 6100. At block 6102, flagged copied entries are recorded in log records that are embedded into an audit group of the HDF5 file. The method 6000 continues to decision block 6104 where a test is performed to determine whether all the data load data sets have been processed. If the answer to the test at decision block 6104 is NO, the method continues to another continuation terminal (“Terminal A6”) and skips back to block 6094 where the above-identified processing steps are repeated. If the answer to the test at decision block 6104 is YES, the method 6000 proceeds to block 6106 where the summary statistics are calculated for the genotype data contained in the study data set. At block 6108, the summary statistics are stored as one-dimensional tables in the HDF5 data file. The method 6000 then proceeds to another continuation terminal (“Terminal A7”).

From Terminal A7, the method 6000 proceeds to block 6110 where additional index structures are added to the HDF5 file allowing quick mapping of individual, marker identifiers to row, column indices in the genotype call data matrices. At block 6112, the user uses the table viewer of the integrated genomic system 102 to view and manually inspect the study data sets. Individual genotype call entries can be modified by the user using the method 6000 at block 6114. If a genotype call is altered, a corresponding log record is produced to the audit group of the HDF5 file at block 6116. At block 6118, after inspection is finished, the HDF5 file is saved to a disk, causing a hash digest to be calculated over the content of the genotyping data and the information recorded in the audit group. The hash digest is also stored as part of the HDF5 file. See block 6120. At block 6122, if the study data set of the HDF5 file is published to a community of the integrated genomic system 102, a data file is added to a WEBDAV repository. At block 6124, an audit trail can be reconstructed for each individual and marker from which data load and sample of the genotype call was derived or changed, and the time occurred. The method then continues to the exit Terminal D.

From Terminal D (FIG. 6A), the method 6000 proceeds to a set of method steps 6006, defined between a continuation terminal (“Terminal E”) and an exit terminal (“Terminal F”). The set of method steps 6006 describes creation of an analysis data set to observe interactions in biological systems and configuration of analysis tools.

From Terminal E (FIG. 6L), the method 6000 proceeds to block 6126 where a study data set from which an analysis data set to be created is selected, the analysis data set being a two-dimensional data organization that references genotype information. At block 6128, cut-off values for various quality control (QC) parameters are specified. The QC parameters include summary statistics that can be computed on individuals or markers, such as genotype call rates, Hardy-Weinberg scores, or minor allele frequencies. See block 6130. The Hardy-Weinberg score is based on the Hardy-Weinberg equilibrium in the domain of population genetics. The law of Hardy-Weinberg states that, under certain conditions, after one generation of random mating, the genotype frequencies at a single gene locus will become fixed at a particular equilibrium value. It also specifies that those equilibrium frequencies can be represented as a simple function of the allele frequencies at that locus. The minor allele frequency describes within a population SNPs that can be assigned a ratio of chromosomes in a population carrying the less common variant to those with a more common variant.

At block 6132, based on the parameters and their cut-off values, certain individuals, markers, or both get included or excluded from the study data set. The resulting two-dimensional table of included genotyping data is an object for further quality control statistics computation. See block 6134. At block 6136, the integrated genomic system presents the two-dimensional table of included genotyping data and its QC statistics computation. At block 6138, if a user is satisfied, the metadata used to create the analysis data set, which is a reference to the study data set as well as the cut-off values for the QC parameters, can be saved. At block 6140, to publish, the saved analysis data set is exposed by the WEBDAV repository in which access control can be set. The method 6000 then continues to another continuation terminal (“Terminal E1”).

From Terminal E1 (FIG. 6M), the method 6000 proceeds to decision block 6142 where a test is performed to determine whether the user wishes to access external analysis tools. If the answer to the test at decision block 6142 is NO, the method 6000 proceeds to the exit Terminal F and terminates execution. If the answer to the test at decision block 6142 is YES, the method continues to block 6144 where the user prepares to create a file format configuration by identifying a source (for export) or a target (for import) data object in the integrated genomic system. The specification of an overall file structure is provided (one-dimensional, two-dimensional, delimiters, headers, and so on). See block 6146. At block 6148, the mapping of fields in the external file format to data fields in the integrated genomic system is executed. At block 6150, the user prepares to configure an external program. The method then continues to another continuation terminal (“Terminal E2”). From Terminal E2 (FIG. 6N), the user specifies the programming language in which the external tool is written. See block 6152. At block 6154, the user specifies supported operating platforms as used by the integrated genomic system to determine the availability of the analysis tool in a heterogeneous computing environment. At block 6156, the user specifies the main program executable or script (different for each target operating system platform) and library and data resources. At block 6158, the user specifies configuration parameters, inputs, and outputs, which decompose the command line of the external tool into fixed placeholders to be filled upon invocation of the external tool. See block 6158. The method continues to decision block 6160 where a test is performed to determine whether the user wishes to invoke an external analysis tool. If the answer to the test at decision block 6160 is NO, the method continues to exit Terminal F and terminates execution. If otherwise the answer to the test at decision block 6160 is YES, the method continues to another continuation terminal (“Terminal E3”).

From Terminal E3 (FIG. 6O), the user selects an initial data object in the integrated genomic system workspace that will be a valid argument to an external analysis tool. See block 6162. At block 6164, the user selects an external analysis tool from a menu. The system then presents a forum to capture input arguments and parameters for the tool including references to other input objects. See block 6166. The user initiates to execution either on a client machine that the user is operating or submits to a server for remote execution at block 6168. At block 6170, once a job is being processed, any missing input is downloaded from the WEBDAV server into the local workspace tree. At block 6172, for each object that needs to be converted into an external file format, a temporary input file is created using a file format template earlier specified. For each object that needs to be converted into an external file format, a temporary input file is created using a file format template earlier specified. See block 6174. The method 6000 then continues to another continuation terminal (“Terminal E4”).

From Terminal E4 (FIG. 6P), the method 6000 proceeds to block 6176 where if the analysis tool is not present yet on the machine on which the analysis jobs are to be executed, the tool and required libraries are downloaded from the WEBDAV repository. At block 6178, when all data and programs are in place, the external analysis tool is executed by passing argument values as specified by the analysis tool configuration. After completion, an HDF5-based analysis result object is created at block 6180. At block 6182, the HDF5 result object is formed from the file format transformation template. At block 6184, metadata describing the input data and parameters used to create the analysis result are attached to the result object. If the analysis tool was executed remotely, the result is published by the WEBDAV repository. See block 6186. The method then continues to exit Terminal F and terminates execution.

While illustrative embodiments have been illustrated and described, it will be appreciated that various changes can be made therein without departing from the spirit and scope of the invention.

1. A group of networked computers for viewing influences on interactions in biological systems selected from a group consisting of genetic background, infection stages, environmental states, life-style choices, and social structures, the group of networked computers comprising:
a client application being executed on a client machine through which a user accesses a visual interface for viewing influences on interactions in biological systems;
an application server being executed on a server machine for hosting applications and a job execution framework for off-loading jobs from the client application and automatically executing the jobs comprising the importation of biological data, statistical analyses, and the transformation of biological data;
a compute cluster including job submission queues and cluster nodes being stored on a computer-executable medium, the cluster nodes including a head node, the head node being accessible by the server machine, the job submission queues being accessible by the job execution framework to place off-loaded jobs, input data of each job being transferred to the head node, the details of each job being transferred to a job submission queue of a cluster node of the compute cluster where the job is executed to produce biological analysis results;
a relational database server storing reference information for genetic studies, participating study populations, and genetic markers that are under investigation, the relational database server being physically hosted on another server machine that is not the server machine hosting the application server; and
a web-enabled collaborative document repository server, which is used to store and access two-dimensionally indexed data structures containing data matrices of genotype calls organized by study individual and genetic marker, the web-enabled collaborative document repository server being physically hosted on another server machine that is not the server machine hosting the application server.

2. The group of networked computers of claim 1, wherein the applications include an application for providing a repository of biological reference information including genes and genetic markers.

3. The group of networked computers of claim 1, wherein the applications include an application for providing a repository that captures genetic studies across research projects including the study design underlying a scientific experiment, groups of individuals participating in a study, assay technology used to determine genetic variation, technology-specific information pertaining to genetic markers being targeted in the scientific experiment.

4. The group of networked computers of claim 1, wherein the applications include an application for providing a repository for assay results, each data point in an assay result being linked back to a piece of biological reference information and a piece of study design information.

5. The group of networked computers of claim 1, wherein the applications include an application for implementing quality control procedures to exclude unreliable or questionable data points from analysis.

6. The group of networked computers of claim 1, wherein the applications include an application that transforms a set of genetic variation measurements into exportable data to a set of analysis tools external to the group of networked computers.

7. The group of networked computers of claim 1, wherein the applications include an application that captures parameters and input values for each analysis result or intermediate steps of data processing to create audit trails from each data point in each analysis result back to a boundary separating the group of networked computers from other computing machinery external to the group of networked computers.

8. In execution on a group of networked computers, a computer-readable medium having computer-executable instructions stored thereon for implementing a method for analyzing interactions in biological systems, the method comprising:
creating a study to capture a population of individuals being genotyped to calculate statistical results about a specific assay used to measure genetic variations for a set of markers;
loading and copying of external genotype data files into data load data sets;
creating a study data set to associate a genotype call to each individual and marker that are associated with the study by reconciling genotype calls for samples across one or more data load data sets; and
creating an analysis data set to focus on a subset of the study data set by restricting the data shown to data points associated with a given individual list and marker list, the analysis data set being a two-dimensional organization of genotype information associated with a set of individuals and markers without using a copy of genotyping data.

9. The computer-readable medium of claim 8, wherein creating a study includes specifying a unique study identifier, species information of organisms under investigation, and the specific genome assembly to be used for analysis, creating a study further including creating an individual panel representing individuals who are participating in the study, each individual being marked with a unique identifier and phenotypic information being extracted from the individual so as to classify the individual into sub-populations, creating a study yet further including selecting one or more marker panels for use in the study, each marker panel determining a kind of genotyping assay results that constitute valid data load data sets within the study.

10. The computer-readable medium of claim 9, wherein loading genotype data includes loading a sample manifest into system memory for identifying samples present in a genotype data matrix, loading the genotype data determining marker panel associated with the genotype data matrix and determining dimensions of the genotype data matrix that needs to be created for loading the genotype data.

11. The computer-readable medium of claim 10, wherein copying genotype data includes creating a first HDF5 file connected with the study data set so that dimensions of data matrices in the first HDF5 file have rows equal to the number of markers and columns equal to the number of individuals, copying genotype data further includes creating a second HDF5 file connected with the data load data set so that dimensions of data matrices in the second HDF5 file have rows equal to the number of markers and columns equal to the number of samples, each matrix being allocated using a block structure that partitions the matrix into blocks of data, each block being associated with a window defined by a range of marker identifications and a range of sample identifications, the window being associated with a queue, copying genotype data including copying data from an external genotype data file into blocks of data by comparing sample identifications and marker identifications of the external genotype data file with the identifier ranges for each window.

12. The computer-readable medium of claim 11, wherein creating a study data set includes selecting one or more data load data sets to be combined into the study data set, creating a study data set further comprising creating a second HDF5 data file that contains a stack of two-dimensional matrices to organize genotyping information for a set of individuals and markers, the set of individuals being a union of all individuals represented in the data load data sets, the set of markers being a union of all markers in the data load data sets.

13. The computer-readable medium of claim 12, wherein creating an analysis data set includes defining a two-dimensional organization of genotype information associated with a subset of individuals and markers extracted from the study data set without containing its own copy of genotyping data.

14. A method for analyzing interactions in biological systems, the method comprising:
creating a study to capture a population of individuals being genotyped to calculate statistical results about a specific assay used to measure genetic variations for a set of markers;
loading and copying of external genotype data files into data load data sets;
creating a study data set to associate a genotype call to each individual and marker that are associated with the study by reconciling genotype calls for samples across one or more data load data sets; and
creating an analysis data set to focus on a subset of the study data set by restricting the data shown to data points associated with a given individual list and marker list, the analysis data set being a two-dimensional organization of genotype information associated with a set of individuals and markers without using a copy of genotyping data.

15. The method of claim 14, wherein creating a study includes specifying a unique study identifier, species information of organisms under investigation, and the specific genome assembly to be used for analysis, creating a study further including creating an individual panel representing individuals who are participating in the study, each individual being marked with a unique identifier and phenotypic information being extracted from the individual so as to classify the individual into sub-populations, creating a study yet further including selecting one or more marker panels for use in the study, each marker panel determining a kind of genotyping assay results that constitute valid data load data sets within the study.

16. The method of claim 15, wherein loading genotype data includes loading a sample manifest into system memory for identifying samples present in a genotype data matrix, loading the genotype data determining marker panel associated with the genotype data matrix and determining dimensions of the genotype data matrix that needs to be created for loading the genotype data.

17. The method of claim 16, wherein copying genotype data includes creating a first HDF5 file connected with the study data set so that dimensions of data matrices in the first HDF5 file have rows equal to the number of markers and columns equal to the number of individuals, copying genotype data further includes creating a second HDF5 file connected with the data load data set so that dimensions of data matrices in the second HDF5 file have rows equal to the number of markers and columns equal to the number of samples, each matrix being allocated using a block structure that partitions the matrix into blocks of data, each block being associated with a window defined by a range of marker identifications and a range of sample identifications, the window being associated with a queue, copying genotype data including copying data from an external genotype data file into blocks of data by comparing sample identifications and marker identifications of the external genotype data file with the identifier ranges for each window.

18. The method of claim 17, wherein creating a study data set includes selecting one or more data load data sets to be combined into the study data set, creating a study data set further comprising creating a second HDF5 data file that contains a stack of two-dimensional matrices to organize genotyping information for a set of individuals and markers, the set of individuals being a union of all individuals represented in the data load data sets, the set of markers being a union of all markers in the data load data sets.

19. The method of claim 18, wherein creating an analysis data set includes defining a two-dimensional organization of genotype information associated with a subset of individuals and markers extracted from the study data set without containing its own copy of genotyping data.
